(19) United States
(12) Patent Application Publication
(10) Pub. No.: US 2023/0402682 A1
(43) Pub. Date: Dec. 14, 2023

(54) TWO-PHASE CONTROL VALVE FOR ELECTRICAL POWER SYSTEM

(71) Applicant: Raval A.C.S. Ltd., Beer-Sheva (IL)

(72) Inventors: Omer Vulkan, D.N. Hanegev Kibbutz Mishmar Hanegev (IL); Denis Kleyman, Mabu'im (IL); Gady Huberman, Beer-Sheva (IL); Nahshon Eadelson, Moshav Sde-Avraham (IL); Eitam Friedman, Meitar (IL); Bar Ben-Horin, Yeruham (IL)

(21) Appl. No.: 18/035,214

(22) PCT Filed: Jan. 19, 2022
(86) PCT No.: PCT/IL2022/050082

§ 371 Date: May 3, 2023

Related U.S. Application Data
(60) Provisional application No. 63/139,588, filed on Jan. 20, 2021.
(60) Provisional application No. 63/193,371, filed on May 26, 2021.

(51) Int. Cl. H01M 10/6569; F16K 11/16; F16K 24/04; H01M 10/625; H01M 10/6567; B60K 15/035

(52) U.S. Cl. CPC H01M 10/6569; F16K 11/161; F16K 24/044; H01M 10/625; H01M 10/6567; B60K 15/03519; H01M 2220/20

(57) ABSTRACT

A two-phase valve is provided, including a valve body configured for being at least partially immersible in a liquid phase of a working fluid. The valve body includes a first valve arrangement and a second valve arrangement. The first valve arrangement defines a first flow path for enabling venting vapor phase of the working fluid therethrough when the first valve arrangement is open, and the first valve arrangement is configured for selectively closing the first flow path when the liquid phase of the working fluid has a liquid level not less than a first threshold value. The second valve arrangement defines a second flow path for enabling passage of the liquid phase of the working fluid therethrough when the second valve arrangement is open, and the second valve arrangement is configured for selectively closing the second flow path when the liquid level of the liquid phase of said working fluid is not less than a second threshold value. The second threshold value is lower than the first threshold value.

### TECHNOLOGICAL FIELD

The presently disclosed subject matter relates to electrical power systems, in particular to electrical power systems comprising electrical batteries and a cooling system for enabling cooling of the electrical batteries, more in particular to such electrical power systems for use in electrically powered vehicles.

### BACKGROUND

Electrically powered vehicles, in particular cars, are becoming progressively more popular, and are considered to address a demand for reducing global consumption of fossil fuels and for reducing global emission of greenhouse gases.

Such vehicles require an electrical power source, conventionally in the form of electrical batteries, and more recently in the form of battery modules comprising a plurality of electrical batteries.

Cooling of such electrical batteries presents a challenge, and one proposed solution is an immersed cooling system based on latent heat of evaporation of a working fluid in direct contact with the batteries.

### GENERAL DESCRIPTION

According to a first aspect of the presently disclosed subject matter there is provided a two-phase valve comprising a valve body configured for being at least partially immersible in a liquid phase of a working fluid, the valve body comprising:
a first valve arrangement, defining a first flow path for enabling venting vapor phase of the working fluid therethrough when the first valve arrangement is open, and wherein the first valve arrangement is configured for selectively closing said first flow path when said liquid phase of said working fluid has a liquid level not less than a first threshold value;
a second valve arrangement, defining a second flow path for enabling passage of said liquid phase of the working fluid therethrough when the second valve arrangement is open, and wherein the second valve arrangement is configured for selectively closing said second flow path when said liquid level of said liquid phase of said working fluid is not less than a second threshold value;
wherein said second threshold value is lower than said first threshold value.

For example, the valve housing defines a first chamber associated with the first valve arrangement, and a second chamber associated with the second valve arrangement. For example, said valve housing comprises a valve inlet port arrangement and an outlet port defining said first flow path, and wherein the first valve arrangement comprises an outlet port sealing member configured for selectively being in full sealing engagement with respect to the outlet port providing a closed configuration for the first valve arrangement, and for being at least partially disengaged with respect to the outlet port providing an open configuration for the first valve arrangement. For example, the first valve arrangement comprises a first float member accommodated in said first chamber, the first float member being reciprocally movable within the first chamber between a first valve uppermost position and a first valve lowermost position, defining a plurality of first valve intermediate positions intermediate between said first valve uppermost position and said first valve lowermost position, the first float member being configured for floating with respect to the liquid phase of the working fluid. For example, said first float member has a density less than a density of the working fluid, and wherein said first float member is made from a material having a density less than the density of the working fluid. Additionally or alternatively, for example, said first float member has a density less than a density of the working fluid, and wherein said first float member is at least partially hollow enclosing a pocket of gas.

In at least some examples, additionally or alternatively, for example:
the first float member comprises an inclined top wall portion fitted with the outlet port sealing member, wherein the outlet port sealing member is in the form of an elongated flexible closure membrane strip having a first strip end a second strip end, wherein the elongated flexible closure membrane strip is anchored at said first strip end to an upper part of said top surface, and wherein said second strip end is free; and
the upper valve port is in the form of a slit-like aperture having an inclination generally complementary to an inclination of said top wall portion.

Additionally or alternatively, for example, the two-phase valve has an absence of a spring otherwise biasing the first float member in a direction towards said outlet port. For example, in operation of the first valve arrangement a net upward force is generated by the vector sum of a weight of the first float member and a buoyancy force acting on the first float member when the liquid level is at the first threshold value such as to ensure full sealing engagement between said outlet port sealing member and said outlet port.

Alternatively, the two-phase valve has a first spring otherwise biasing the first float member in a direction towards said outlet port. For example, in operation of the first valve arrangement a net upward force is generated by the vector sum of a weight of the first float member, a spring force generated by the first spring, and a buoyancy force acting on the first float member when the liquid level is at the first threshold value such as to ensure full sealing engagement between said outlet port sealing member and said outlet port.

Additionally or alternatively, for example, said valve housing comprises a valve outlet port arrangement and an inlet port defining said second flow path, and wherein the second valve arrangement comprises an inlet port sealing member configured for selectively being in full sealing engagement with respect to the inlet port providing a closed configuration for the second valve arrangement, and for being at least partially disengaged with respect to the inlet port providing an open configuration for the second valve arrangement. For example, said second valve arrangement comprises a valve member accommodated in said second chamber, the valve member being reciprocally movable within the second chamber between a second valve uppermost position and a second valve lowermost position, defining a plurality of second valve intermediate positions intermediate between the second valve uppermost position and the second valve lowermost position. For example, said second valve arrangement has a normally closed position. Additionally or alternatively, for example, the two-phase valve has a second spring otherwise biasing the valve member in a direction towards said inlet port. For example, in operation of the second valve arrangement a net upward force is generated by the vector sum of a weight of the valve member, a second spring force generated by the second spring, and a second buoyancy force acting on the valve member when the liquid level is at least above the second threshold value such as to bias the inlet port sealing member to sealing engagement with respect to the inlet port. Additionally or alternatively, for example, the two-phase valve comprises a second float member configured for floating with respect to the liquid phase of the working fluid, and wherein the second valve arrangement is configured for opening said second fluid path responsive to an actuation force being applied thereto by the second float member, concurrent with the liquid level being less than said second threshold level. For example, said second float member is unaffixed to said valve member. Additionally or alternatively, for example, at least one of said second float member and said valve member is configured such as to enable the second float member to apply said actuation force to said valve member when said liquid level is below said second threshold value, and to cease applying said actuation force when said liquid level is above said second threshold level. For example, the two-phase valve comprises an actuation member affixed to one of said second float member and said valve member, the actuation member being abuttable with respect to the other one of said second float member and said valve member responsive to said liquid level being not greater than said second threshold value, For example, said actuation member is in the form of rod element, projecting from the valve member towards the second float member. Additionally or alternatively, for example, said actuation force is a vector sum of a weight of the valve member and a buoyancy force of the valve member at said liquid level. For example, said actuation force has a greater magnitude than said net upward force.

Additionally or alternatively, for example, and in at least some examples, said first chamber and said second chamber are in vertical stacked relationship. For example, said first float member comprises said second float member; alternatively, for example, said first float member and said second float member are one and the same float member. Additionally or alternatively, for example, said actuation member projects in a general vertical direction from the valve member.

Additionally or alternatively, for example, and in at least some examples, said first chamber and said second chamber are in lateral stacked relationship. For example, said first float member and said second float member are one and the same float member; additionally or alternatively, for example, said actuation member projects in a general lateral direction from the valve member. Alternatively, for example, said first float member is different from said second float member; for example, said actuation member projects in a general vertical direction from the second float member.

For example, operation of said first valve arrangement and said second valve arrangement is mechanically coupled.

In at least some other examples, said valve housing comprises a valve outlet port arrangement and an inlet port defining said second flow path, and wherein the second valve arrangement comprises a valve unit configured for selectively providing a closed configuration for the second valve arrangement, and for selectively providing an open configuration for the second valve arrangement. For example, said second valve arrangement comprises a float unit coupled with said valve unit. For example, said valve unit comprises a first valve unit chamber separated from a second valve unit chamber via a movable diaphragm member, wherein the diaphragm member comprises a diaphragm aperture providing fluid communication between the first valve unit chamber and the second valve unit chamber, wherein said first valve unit chamber in open fluid communication with said inlet port, and wherein said second valve unit chamber is in selective fluid communication with said second valve chamber via a pilot orifice coupled with said float unit.

Additionally or alternatively, for example, said float unit is reversibly movable between an uppermost position and a lowermost position, wherein said uppermost position corresponds to said liquid level of said liquid phase of said working fluid being not less than said second threshold value, and wherein said lowermost position corresponds to said liquid level of said liquid phase of said working fluid being less than said second threshold value. For example, said float unit is configured for closing fluid communication between said second valve chamber and said second valve via said pilot orifice when said float unit is in said uppermost position, and for opening fluid communication between said second valve chamber and said second valve via said pilot orifice when said float unit is in said lowermost position. Additionally or alternatively, for example, said float unit comprises a second float member rigidly connected to a pilot orifice sealing member, spaced below the second float member via a rod element, wherein said pilot orifice sealing member is configured for sealingly closing said pilot orifice when said float unit is in said uppermost position, and for disengaging from said pilot orifice when said float unit is in said lowermost position.

Additionally or alternatively, for example, said first valve unit chamber accommodates therein a lower valve port that projects towards the diaphragm member, wherein said lower valve port is in fluid communication with said valve outlet port arrangement.

Additionally or alternatively, for example, said diaphragm member is configured for selectively sealing the lower valve port, to thereby close said second flow path responsive to said float unit being in said uppermost position, and wherein said diaphragm member is configured for selectively unsealing the lower valve port, to thereby open said second flow path responsive to said float unit being in said lowermost position.

Additionally or alternatively, for example, said valve unit comprises a first housing portion and a second housing portion, wherein said diaphragm member is clamped between the first housing portion and the second housing portion.

Additionally or alternatively, for example, a central portion of the diaphragm member is selectively movable along a valve unit axis orthogonal with respect to a longitudinal axis of the second valve arrangement. For example, said second valve unit chamber accommodates a diaphragm biasing arrangement. For example, said diaphragm biasing arrangement comprises spring and piston member. For example, said spring has one longitudinal end thereof anchored in the second housing portion, and an opposed longitudinal end thereof affixed to the piston member, wherein said piston member abuts said diaphragm member, and wherein said spring biases the diaphragm member against said lower valve port via said piston member.

Additionally or alternatively, for example, said second housing portion comprises a pilot lumen providing fluid communication between the second valve unit chamber and said pilot orifice.

Additionally or alternatively, for example, operation of said first valve arrangement and said second valve arrangement are mechanically uncoupled.

Additionally or alternatively, for example, said first chamber and said second chamber are in vertical stacked relationship.

Additionally or alternatively, for example, said first chamber and said second chamber are in lateral stacked relationship.

Additionally or alternatively, for example, said first float member is different from said second float member.

Additionally or alternatively, for example, said diaphragm aperture is smaller than or equal to in size with respect to the pilot orifice.

Additionally or alternatively, for example, said diaphragm aperture has a diameter between about 0.1 mm and about 0.2 mm.

Additionally or alternatively, for example, said pilot orifice a diameter between about 0.2 mm and about 0.3 mm.

For example, said working fluid is a two-phase fluid that vaporizes by absorbing heat energy corresponding to the latent heat of evaporation of the fluid.

According to a second aspect of the presently disclosed subject matter there is provided a cooling system for at least one battery module, comprising a cooling recirculation circuit and at least one two-phase valve as defined herein regarding the first aspect of the presently disclosed subject matter.

For example, said cooling recirculation circuit comprises a vapor phase line including a compressor, a liquid phase return line including a liquid pump, and a condenser.

Additionally or alternatively, for example, the cooling system comprises at least one pressure check valve and at least one pressure holding function valve.

Additionally or alternatively, for example, said vapor phase line is connected to the respective outlet port of each said two-phase valve, and wherein said liquid phase line is connected to the respective inlet port of each said two-phase valve.

According to a third aspect of the presently disclosed subject matter there is provided a battery module comprising a housing defining a module chamber accommodating a plurality of electrical batteries, and further comprising at least one two-phase valve as defined herein regarding the first aspect of the presently disclosed subject matter.

For example, said batteries are immersed in a liquid phase of the working fluid in said module chamber.

Additionally or alternatively, for example, said at least one two-phase valve is operatively connectable to a cooling system.

According to a fourth aspect of the presently disclosed subject matter there is provided an electrical power system, comprising:
at least one battery module a module chamber accommodating a plurality of electrical batteries, and further comprising at least one two-phase valve as defined herein regarding the first aspect of the presently disclosed subject matter;
a cooling recirculation circuit operatively connected to said at least one battery module.

For example, said cooling recirculation circuit comprises a vapor phase line including a compressor, a liquid phase return line including a liquid pump, and a condenser.

Additionally or alternatively, for example, the electrical power system comprises at least one pressure check valve and at least one pressure holding function valve.

Additionally or alternatively, for example, said vapor phase line is connected to the respective outlet port of each said two-phase valve, and wherein said liquid phase line is connected to the respective inlet port of each said two-phase valve.

Additionally or alternatively, for example, for each said battery module, the respective said batteries are immersed in a liquid phase of the working fluid in said module chamber.

Additionally or alternatively, for example, each said battery module comprises two said two-phase valves. For example, for each said battery module, the respective said two two-phase valves are longitudinally spaced with respect to one another.

For example, the electrical power system comprises a plurality of said battery modules.

According to a fifth aspect of the presently disclosed subject matter there is provided a vehicle comprising an electrical propulsion system and an electrical power system as defined herein regarding the fourth aspect of the presently disclosed subject matter.

For example, said vehicle is a road vehicle.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of an electrical power system according to a first example of the presently disclosed subject matter.

FIG. 2 is a schematic illustration of an alternative variation of the example of FIG. 1.

FIG. 3 is a cross-sectional view of a two-phase valve according to a first example of the presently disclosed subject matter, for example for use in the example of the electrical power system of FIG. 1 of FIG. 2.

FIG. 4 illustrates the valve of the example of FIG. 3 in flooded mode.

FIG. 5 illustrates the valve of the example of FIG. 3 in vent mode.

FIG. 6 illustrates the valve of the example of FIG. 3 in vent/fill mode.

FIG. 7(a) illustrates in isometric view an example of a battery configuration and arrangement in a battery module of the example of FIG. 1 or FIG. 2; FIG. 7(b) illustrates in isometric view another example of a battery configuration and arrangement in a battery module of the example of FIG. 1 or FIG. 2; FIG. 7(c) illustrates in isometric view another example of a battery configuration and arrangement in a battery module of the example of FIG. 1 or FIG. 2.

FIG. 8(a) schematically illustrates in side view an example of a battery module comprising two longitudinally spaced valves, in which the battery module is in a horizontal orientation; FIG. 8(b) schematically illustrates in side view the example of FIG. 8(a) in which the battery module is tilted in one direction by angle α; FIG. 8(c) schematically illustrates in side view the example of FIG. 8(b) in which the battery module is tilted back to the horizontal position after the tilted position of FIG. 8(b); FIG. 8(d) schematically illustrates in side view the example of FIG. 8(c) in which the battery module is tilted in the other direction, by angle-α.

FIG. 9 is a cross-sectional view of an alternative variation of the example of the two-phase valve of FIG. 3.

FIG. 10 is a cross-sectional view of another alternative variation of the example of the two-phase valve of FIG. 3.

FIG. 11 is a cross-sectional front view of a two-phase valve according to a second example of the presently disclosed subject matter, for example for use in the example of the electrical power system of FIG. 1 of FIG. 2; FIG. 11(a) is a cross-sectional side view of the example of FIG. 11 taken along A-A; FIG. 11(b) is a cross-sectional front view of the second valve arrangement of the example of FIG. 11.

FIG. 12(a) is a cross-sectional side view of the first valve arrangement of the example of FIG. 11, showing a first flow path therethrough; FIG. 12(b) is a cross-sectional front view of the second valve arrangement of the example of FIG. 11, showing a second flow path therethrough.

FIG. 13 is a cross-sectional front view of the example of FIG. 11, with the valve operating in flooded mode; FIG. 13(a) is a partial cross-sectional side view of the example of FIG. 13.

FIG. 14 is a cross-sectional front view of the example of FIG. 11, with the valve operating in vent mode; FIG. 14(a) is a partial cross-sectional side view of the example of FIG. 14.

FIG. 15 is a cross-sectional front view of the example of FIG. 11, with the valve operating in vent/fill mode; FIG. 15(a) is a partial cross-sectional side view of the example of FIG. 15.

### DETAILED DESCRIPTION

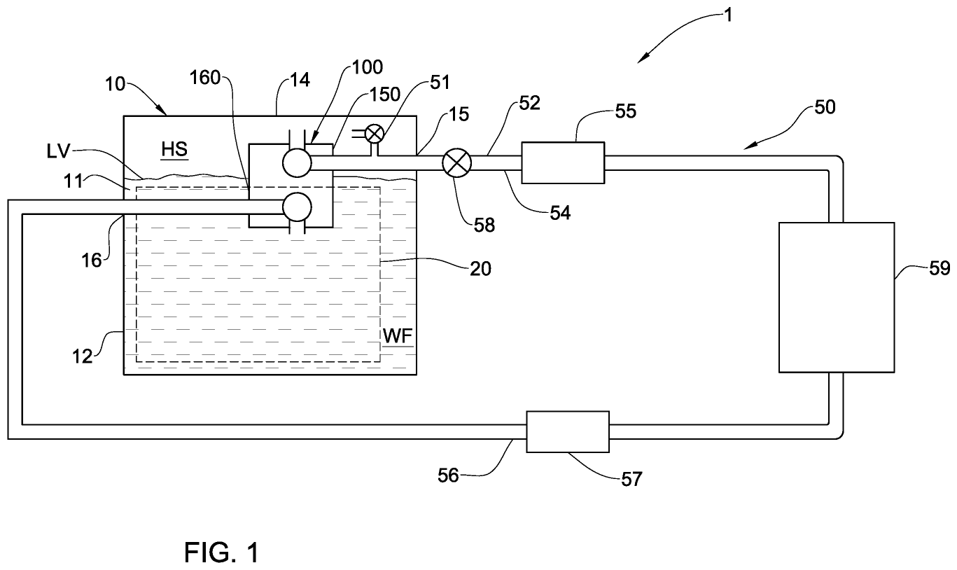

Referring to FIG. 1, an electrical power system according to a first example of the presently disclosed subject matter, generally designated with reference numeral 1, comprises a battery module 10 and a cooling system 50.

According to this aspect of the presently disclosed subject matter, a vehicle, such as for example a ground vehicle, comprises an electrical propulsion system, and the electrical power system 1 is in electrical communication with, i.e., electrically coupled with, the electrical propulsion system; the electrical propulsion comprises one or more electric motors, and the electrical propulsion forms the main propulsion system or the only propulsion system of the vehicle. In alternative variations of this example, the vehicle can have a hybrid propulsion system, and the electrical propulsion system form part of the hybrid propulsion system.

The battery module 10 comprises a housing 12 defining a chamber 11 accommodating a plurality of electrical batteries 20. The batteries 20 are laterally stacked, i.e., in laterally adjacent spaced disposition, in the chamber 11, and are spaced laterally from one another by a suitable inter-battery spacing, typically less than 2 mm, for example about 1.7 mm, and sufficient to allow the liquid phase of the working fluid WF to contact all or most the external surfaces of the batteries 20, and to generally maintain such contact even concurrent with part of the working fluid WF vaporizing to the vapor phase.

For example, such batteries 20 can be lithium-ion batteries, as are well known in the art.

In at least this example, the housing 12, and the chamber 11, are each generally parallelopiped in shape, in particular in the form of a rectangular cuboid.

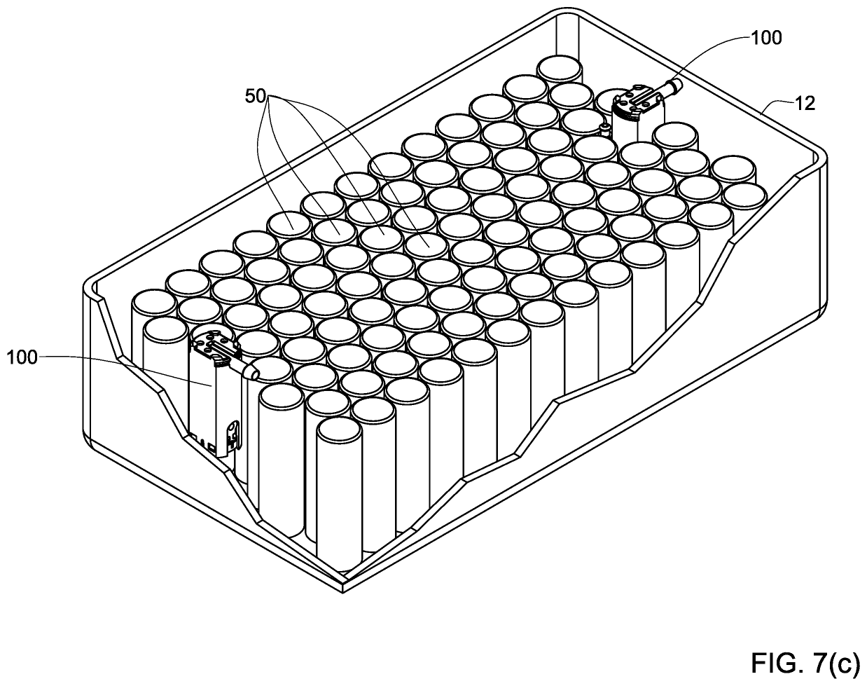

The batteries 20 can be of any suitable form, for example in prismatic form (see FIG. 7(a)), in pouch configuration (see FIG. 7(b)), or in cylindrical configuration (FIG. 7(c)). The batteries 20 are immersed in a working fluid WF present in the respective chamber 11, leaving a head space HS between the level LV of the liquid phase of working fluid WF and the inside of the top wall 14 of the housing 12, i.e., within chamber 11.

The working fluid WF can be considered part of the cooling system 50.

The working fluid WF is configured for changing phase from liquid phase to vapor phase by extracting the excess heat from the batteries 20 corresponding to the latent heat of the working fluid WL.

Examples of such a working fluid WF can include, for example, any one of: Novec 7000, provided by 3M; HTF-24, provided by Versatill; Optein MZ—provided by Chemours.

For example, the change of phase from liquid to vapor can occur at a specific temperature and pressure, and the working fluid WF can be chosen such that provides the optimal working temperature for the batteries during operation of the electrical power system 1. For example, such an optimal working temperature can be in the range about to about 40° C.

The cooling system 50 comprises a cooling recirculation circuit 52, comprising a vapor phase line 54 including a compressor 55, a liquid phase return line 56 including a liquid pump 57, and a condenser 59.

For example, the compressor 55 can include any suitable vacuum pump or any suitable gas or vapor pump, configured for pumping vapor phase of the working fluid WF, for example a suitable low pressure vacuum generator or a suitable two-phase direct contact heat pump.

For example, the liquid pump 57 can comprise any suitable liquid pump configured for pumping liquid phase of the working fluid WF.

The battery module 10 further comprises a two-phase valve, which is per se novel, and which is coupled to the cooling system 50, as will become clearer herein.

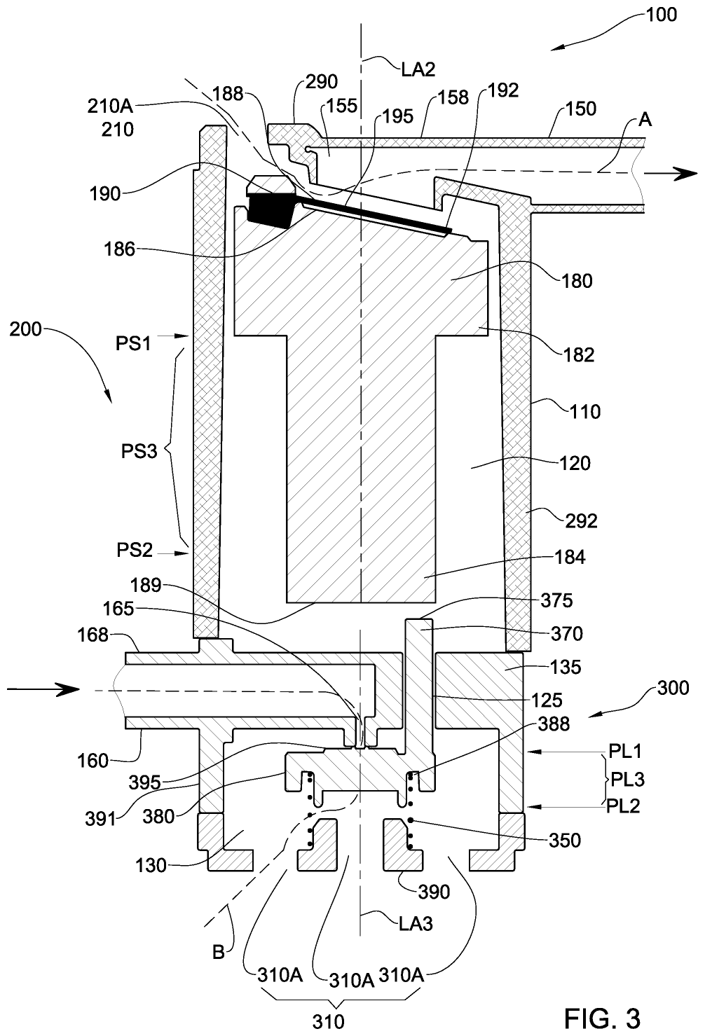

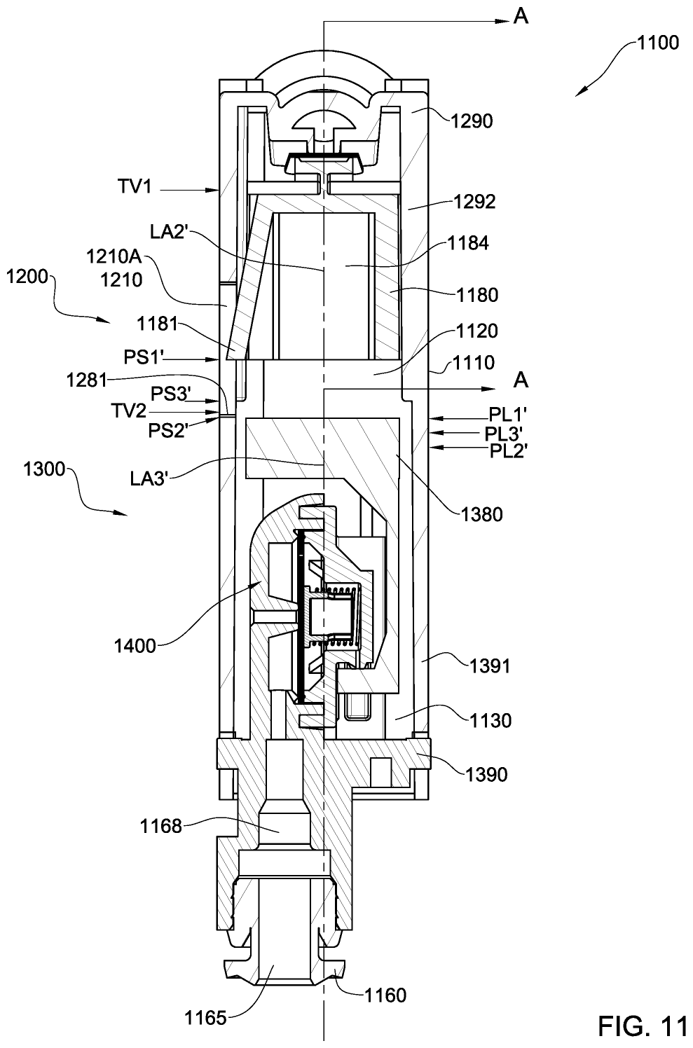

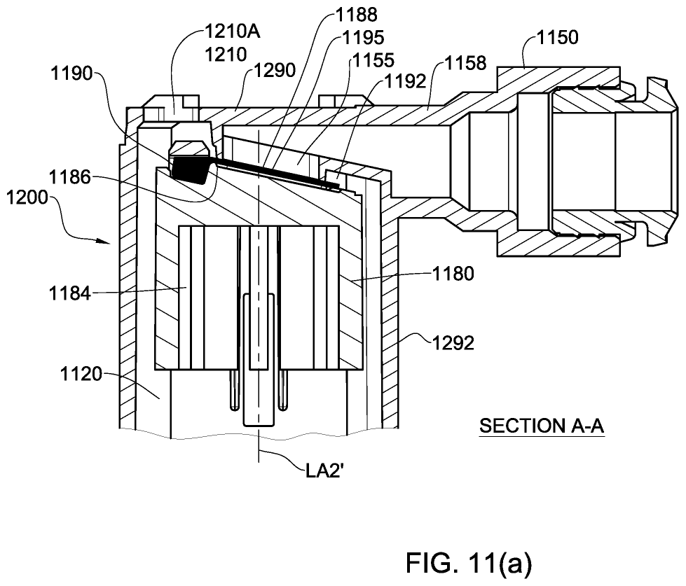

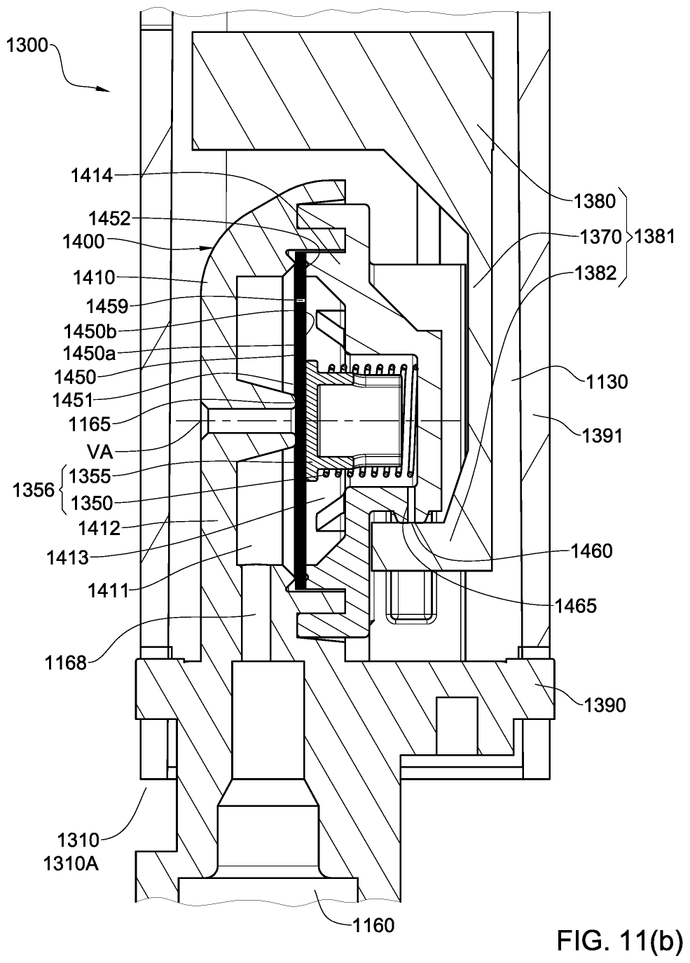

As will become clearer herein, FIG. 3 illustrates a first example of the two-phase valve, designated with reference numeral 100, while FIG. 11 illustrates a second example of the two-phase valve, designated with reference numeral 1100.

Also as will become clearer herein, the respective two-phase valve 100 or 1100 operates to selectively allow vapor phase of the working fluid WF in the headspace HS of the chamber 11, to be pumped to the condenser 59 (via the vapor phase line 54 and the compressor 55), whereupon the vapor phase of the working fluid WF is condensed to liquid phase thereof, and the condensed liquid phase is returned to the chamber 11 via liquid phase return line 56, liquid pump 57, and valve 100 or 1100.

The battery module 10 comprises an outlet port 15 and an inlet port 16.

The outlet port 15 is located in the housing 12, opening into the headspace HS. The outlet port 15 is coupled to the vapor phase line 54.

The inlet port 16 is located in the housing 12, for example the bottom thereof, opening into the liquid phase of the working fluid WF in the chamber 11. The inlet port 16 is coupled to the liquid phase line 56.

As will become clearer herein, regarding the first example, the inlet port 16 is coupled to a liquid phase inlet port 160 of the valve 100, and the outlet port 15 is coupled to a vapor phase outlet port 150 of the valve 100. As mentioned before, the valve 100 comprises a vapor phase outlet port 150 configured for being coupled to the outlet port and a liquid phase inlet port 160 configured for being coupled to inlet port 16.

Also as will become clearer herein, regarding the second example, the inlet port 16 is coupled to a liquid phase inlet port 1160 of the valve 1100, and the outlet port 15 is coupled to a vapor phase outlet port 1150 of the valve 1100. As mentioned before, the valve 1100 comprises a vapor phase outlet port 1150 configured for being coupled to the outlet port 15, and a liquid phase inlet port 1160 configured for being coupled to inlet port 16.

Optionally, the housing 12 can include one or more pressure check valves 51 (for example an all pressure relief function valve) at or close to the top wall 14, and in fluid communication with the head space HS, to relieve any over-pressure in the head space HS at a predetermined value.

The cooling recirculation circuit 52, in particular the vapor phase line 54 can further comprise a pressure holding function valve 58, for ensuring that there is no recirculation of vapor phase to the recirculation circuit 50 when the pressure in headspace HS falls below a predetermined value. For example, such a pressure holding function valve 58 can prevent flow communication therethrough when external environmental temperature is below 10° C.

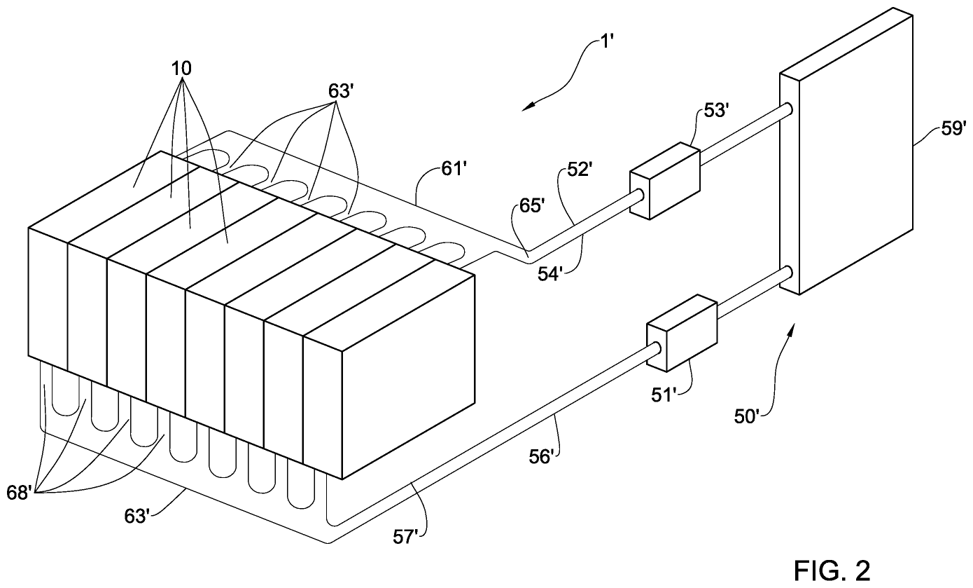

In an alternative variation of the above example, and referring to FIG. 2, the electrical power system, generally designated with reference numeral 1′, comprises a plurality of said battery modules 10, and a common cooling system 50′. It is to be noted that according to this aspect of the presently disclosed subject matter, a vehicle, such as for example a ground vehicle, comprises the electrical power system 1′, in electrical communication with one or more electric motors, which form the main propulsion system of the vehicle.

The common cooling system 50′ in this example is similar to the cooling system of the example of FIG. 1, mutatis mutandis, and comprises a cooling recirculation circuit 52′ comprising a vapor phase line 54′ including a compressor 55′, a liquid phase return line 56′ including a liquid pump 57′, and a condenser 59′, similar to the circuit 52, vapor phase line 54, compressor 55, liquid phase return line 56, liquid pump 57, and condenser 59, as described above, mutatis mutandis. However, in the example of FIG. 2, the cooling system 50′ services all the battery modules 10 of the aforesaid plurality, via a common outlet manifold 61′ and an inlet manifold 63′, instead of just a single battery module 10.

Each battery module 10′ comprises a housing 12′ that can include one or more pressure check valves 51′, similar to the battery module 10, housing 12 and one or more pressure check valves 51, respectively, as described above, mutatis mutandis.

The outlet manifold 61′ comprises a manifold outlet 65′, coupled to the vapor phase line 54′, and a plurality of manifold inlets 66′, each manifold inlet 66′ being coupled to a respective outlet port 15 of a different said battery module 10.

The inlet manifold 63′ comprises a manifold inlet 67′, coupled to the liquid phase line 56′, and a plurality of manifold outlets 68′, each manifold outlet 68′ being coupled to a respective inlet port 16 of a different said battery module 10.

The cooling recirculation circuit 52′, in particular the vapor phase line 54′ can further comprise a pressure holding function valve 58′, provided at each respective manifold inlet 66′ of a different said battery module 10, for ensuring that there is no recirculation of vapor phase to the recirculation circuit 50′ when the pressure in headspace HS in each respective battery module 10 falls below a predetermined value. For example, such a pressure holding function valve 58′ can prevent flow communication therethrough when external environmental temperature is below 10° C.

Referring to FIG. 3, a two phase valve according to a first example of the presently disclosed subject matter, generally designated with reference numeral 100, comprises an first valve arrangement 200 and a second valve arrangement 300.

While in at least this example the first valve arrangement 200 and the second valve arrangement 300 are integrated in a unitary device, in alternative variations of this example, the first valve arrangement 200 and the second valve arrangement 300 can be provided as separate devices, which can also operate independently of one another.

In any case, the valve 100 is configured for ensuring the following:
that liquid phase of the working fluid WF is prevented from recirculating to the condenser 59 (or 59′) via the respective vapor phase line 54 (or 54′);
that only vapor phase of the working fluid WF selectively recirculates to the condenser 59 (or 59′) via the respective vapor phase line 54 (or 54′), when the liquid level LV therein drops below a first threshold value TV1;
that liquid phase of working fluid WF is selectively ingressed into the chamber 11 only when the liquid level LV therein drops below a second threshold value TV2;
that vapor phase of the working liquid WL is prevented from recirculating to the condenser 59 (or 59′) via the respective vapor phase line 54 (or 54′) when the chamber 11 is flooded (over-full).

The valve 100 comprises a valve housing 110 (also interchangeably referred to herein as a valve body) configured for being at least partially immersed in the liquid phase of the working fluid WF. The valve housing 110 defines a first chamber 120 associated with the first valve arrangement 200, and a second chamber 130 associated with the second valve arrangement 300.

In at least this example, the first chamber 120 and the second chamber 130 are in vertical stacked relationship.

As will become clearer herein, the first valve arrangement 200 defines a first flow path A for enabling venting vapor phase of the working fluid WF to vent therethrough when the first valve arrangement 200 is open, the first valve arrangement 200 being configured for selectively closing said flow path A when a liquid level LV of said liquid phase of said working fluid WF is not less than a first threshold value TV1.

Also as will become clearer herein, the second valve arrangement 300 defines a second flow path B for enabling passage of said liquid phase of the working fluid WF therethrough when the second valve arrangement 300 is open, the second valve arrangement 300 being configured for selectively closing said flow path B when a liquid level LV of said liquid phase of said working fluid WF is not less than a second threshold value TV2. According to this aspect of the presently disclosed subject matter, the second threshold value TV2 is lower than said first threshold value TV1.

As will become clearer herein, operation of the second valve arrangement 300 is mechanically coupled to the first valve arrangement 200.

In at least this example the valve housing 110 comprises an upper wall 290, upper side wall 292, and partition wall 135 defining the first chamber 120. Also in at least this example the valve housing 110 also comprises a lower side wall 391 and bottom wall 390, which together with the partition wall 135 define the second chamber 130.

The valve housing 110 is configured for being fixedly mounted with respect to the battery module 10.

It is to be noted that valve housing 110 is configured for allowing liquid phase of the working fluid to readily enter and leave the first chamber 120 and the second chamber 130, such that the level of liquid phase of the working fluid inside the valve 100, in particular inside the valve housing 110, as well as in the liquid level in the first chamber 120 and/or the second chamber 130 corresponds to the liquid level LV in chamber 11.

As mentioned before, the valve 100 comprises a vapor phase outlet port 150 configured for being coupled to the outlet port 15, and a liquid phase inlet port 160 configured for being coupled to inlet port 16.

The vapor phase outlet port 150 is in fluid communication with an upper valve port (also interchangeably referred to herein as outlet port) 155 via outlet conduit 158. In at least this example, the outlet conduit 158 is in the form of a tube extending generally laterally with respect to the longitudinal axis LA2 of the first valve arrangement 200.

The first valve arrangement 200 comprises a float member 180 accommodated in first chamber 120. The float member 180 is reciprocally movable (along the longitudinal axis LA2) within the first chamber 120 between an uppermost position PS1 and a lowermost position PS2, defining a plurality of intermediate positions PS3 intermediate between the uppermost position PS1 and the lowermost position PS2, as will become clearer herein.

The float member 180 comprises an upper float portion 182 and a lower float portion 184 joined to one another, integrally or otherwise connected to one another.

In at least this example, the float member 180 has a density less than the density of the working fluid WF, and is thus configured for floating on such a working fluid WF. For example, the float member can be made from a material having a density less than the density of the working fluid WF and/or can be at least partially hollow enclosing a pocket of gas.

For example, the working fluid can have a specific gravity of 1.28, while the float member 180 can have a specific gravity of less than 1.28, for example 1.1.

For example, the float member 180 can be made from Nylon, and the working fluid WF is HTF-24, provided by Versatill.

The float 180, in particular the upper float portion 182, comprises an outlet port sealing member 195 at an upper end thereof. The outlet port sealing member 195 is configured for selectively sealing the upper valve port 155, as will become clearer herein.

In at least this example, the upper float portion 182 is formed at an upper end thereof with an inclined top wall portion 186 fitted with the outlet port sealing member 195, which in this example is in the form of an elongated flexible closure membrane strip 188. The elongated flexible closure membrane strip 188 is anchored at one end 190 thereof to an upper part of the top surface of the upper float portion 182 and the other end 192 of the closure membrane strip 188 is free.

In at least this example, the upper valve port 155 is in the form of a slit-like aperture inclined with respect to a longitudinal axis LA2, generally complementary to the inclination of wall portion 186.

It should be readily understood that when the valve 100 is at least partially immersed in the liquid phase of working fluid WF, such that the liquid level LV (both inside the valve 100 and outside thereof in chamber 11) is at or higher than a threshold value TV1, the buoyancy forces acting on the float member 182 tend to press the membrane strip 188 into sealing engagement with the outlet port 155. On the other hand, at liquid levels LV lower than the threshold value TV1 gravity forces acting on the float member 180 tend to displace the float member 180 away from the outlet port 155 as the float member 180 floats on a descending liquid level, so as to progressively detach the strip membrane 188 from sealing engagement with the outlet port 155.

It is to be noted that in at least this example there is an absence of a spring otherwise biasing the float member 180 in an upward direction towards the upper valve port 155. In this case, the weight of float member 180 acts in a downward direction while the buoyancy force (which depends on the volume of the float member 180) acts in an upward direction, and thus there is a net upward force, corresponding to the vector sum of the weight and buoyancy forces acting on the float, when the liquid level LV is at the first threshold value TV1, and a net downward force when the liquid level LV has dropped such that the float member 180 is no longer floating on the liquid, for example at second threshold value TV2.

However, in alternative variations of this example, a suitable spring can be provided to bias the float member towards or away from the upper valve port 155, and further optionally the float member 180 can have an overall density that is equal to or greater than the density of the liquid phase of the working fluid WF. In one such a case in which the spring biases the float member towards the upper valve port 155, the weight of float member 180 acts in a downward direction while the buoyancy force (which depends on the volume of the float member 180) plus the spring force act in an upward direction, and thus there is a net upward force, corresponding to the vector sum of the weight force, the buoyancy force and the spring force acting on the float, when the liquid level LV is at the first threshold value TV1, and a net downward force when the liquid level LV has dropped such that the float member 180 is no longer floating on the liquid, for example at second threshold value TV2.

In at least this example, it is ensured that at least the upper float portion 182 is axially aligned within the valve housing 110, and in particular the first chamber 120, and that at least the upper float portion 182 does not rotate within the first chamber 120 about the longitudinal axis LA2, thereby ensuring proper sealing of outlet port 155. For this purpose, the first chamber 120 and the float member 180 can be provided with a suitable alignment arrangement, for example mating radially projecting ribs (not shown), to prevent such rotation.

It is to be noted that in alternative variations of this example, the upper valve port 155 and the outlet port sealing member 195 can have different configurations from those illustrated in FIG. 3. It is to be noted that also in these alternative examples, the buoyancy forces acting on the float member 182 tend to press the respective outlet port sealing member 195 into sealing engagement with the outlet port 155, whilst gravity forces acting on the float member 180 tend to displace the float member 180 away from the outlet port 155. Thus, in the example of FIG. 3 and in the above-mentioned other alternative variations thereof, as the level of fluid LV with respect to the valve 100 lowers, the float 180 also displaces in a downward direction with respect to the chamber 120 thereby disengaging the outlet port sealing member 195 from sealing engagement with the outlet port 155 as the float member 180 floats on a descending liquid level.

The lower end of the float 180, in particular the lower end of the second float portion 184, comprises an abutment zone 189, the purpose of which shall be further clarified below.

The first valve arrangement 200 further comprises a valve inlet port arrangement 210 which in operation of the valve 100 is always in open fluid communication with the chamber 11, in particular the headspace HS. While in at least this example the valve inlet port arrangement 210 comprises a single inlet port 210A formed in the upper wall 290, in alterative variations of this example the valve inlet port arrangement 210 alternatively comprises a plurality of inlet ports 210A provided in upper wall 290. In yet other alterative variations of this example the valve inlet port arrangement 210 additionally or alternatively comprises one or more inlet ports formed on an upper portion of upper side wall 292.

In operation of the valve 100, fluid, in particular vapor phase of the working fluid WF, can pass from the chamber 11, in particular from the headspace HS, through the first valve arrangement 200, in particular via the valve inlet port arrangement 210 and the outlet port 155, i.e., along flow path A, only when the outlet port sealing member 195 is not in full sealing engagement with the outlet port 155.

The liquid phase inlet port 160 is in fluid communication with a lower valve port (also interchangeably referred to herein as inlet port) 165 via inlet conduit 168. In at least this example, the inlet conduit 168 is in the form of a tube extending generally laterally with respect to the longitudinal axis LA3 of the second valve arrangement 300.

The second valve arrangement 300 comprises a valve member 380 accommodated in second chamber 130. The valve member 380 is reciprocally movable within the second chamber 130 between an uppermost position PL1 and a lowermost position PL2, defining a plurality of intermediate positions PL3 intermediate between the uppermost position PL1 and the lowermost position PL2, as will become clearer herein.

The valve member 380 in this example has a density less than the density of the working fluid WF, and is thus configured for floating on such a working fluid WF. Alternatively, the valve member 380 can have a density greater than, or equal to, the density of the working fluid WF. The buoyancy forces acting on the valve member 380 will of course depend on the volume of the valve member 380.

The valve member 380 comprises an inlet port sealing member 395 at an upper end thereof. The inlet port sealing member 395 is configured for selectively sealing the lower valve port 165, as will become clearer herein.

In at least this example, the lower valve port 165 is in the form of a circular aperture orthogonal with respect to a longitudinal axis LA3 of the second valve arrangement 300, and has an annular periphery, sealable with respect to inlet port sealing member 395.

The valve member 380 is biased in an upward direction towards the lower valve port 165 by a spring 350. The spring 350 has one longitudinal end thereof anchored in a bottom wall 390 of the second valve chamber 130, and an opposed longitudinal end thereof anchored in groove 388 formed in the bottom side of the valve member 380.

It should be readily understood that the buoyancy forces acting on the valve member 380 together with the elastic force in the spring 350 tend to press the valve member 380, in particular the inlet port sealing member 395, into sealing engagement with the lower valve port 165, whilst gravity forces and the fluid pressure force from the liquid phase line are acting on the valve member 380 in the opposite direction.

In operation of the second valve arrangement 300 in which the valve member 380 is always submerged in the liquid phase of the working fluid WF, the weight of the valve member 380 together with the fluid pressure force from the liquid phase line are acting on the valve member 380 are together always less than the spring force and buoyancy forces acting in an upward direction, and thus the valve member 380 is in a normally closed position with respect to the lower valve port 165. Thus, the weight, volume and density of the valve member 380, and the spring 350 are chosen such as to maintain this relationship with respect to the liquid phase of the working fluid WF.

Thus, in the absence of any other external forces acting on the valve member 380, the valve member 380 remains in a normally closed position even when fully immersed in liquid phase of the working fluid WF. As will become clearer herein, such an external force is selectively provided by the weight of the float member 180 under predetermined conditions, to enable the valve member 380 to open the second valve 300.

It is to be noted that in alternative variations of this example, the lower valve port 165 and the outlet port sealing member 395 can have different configurations from those illustrated in FIG. 3.

In any case, the valve member 380 further comprises an actuation member in the form of rod element 370, projecting from the valve member 380 in an upward direction and into the first valve chamber 120 via an aperture 125 formed in the partition wall 135 between the first chamber 120 and the second chamber 130. In alternative variations of at least this example, the actuation member can project from the float member 180 towards the valve member 380, i.e., in a downward direction and into the second valve chamber 130 via aperture 125. In yet other alternative variations of at least this example, the valve can comprise two actuation elements, one projecting from the float member 180 towards the valve member 380, and the other projecting from the valve member 380 towards the float member 180, each through one or more apertures provided in partition wall 135.

The rod element 370 has a free end 375 that projects into the first valve chamber 120 and is configured for receiving an external actuation force selectively provided by the float member 180. In at least this example, the free end 375 is configured for abutting the lower end of the float 180, in particular the lower end of the second float portion 184, more in particular the abutment zone 189. As will become clearer herein, such abutment occurs under predetermined conditions, where the float 180, in particular the second float portion 184 descends as the level of liquid LV descends to below a second threshold value TV2. In at least this example, the rod element 370, in particular the free end 375 thereof, projects into the first valve chamber 120 in a generally vertical direction.

As also shall become clearer herein, as the level of liquid phase working fluid WF drops below the second threshold value TV2, the weight of the second float portion 184 (in this case, the weight of the float member 180) acts on the rod member 370 via abutment contact between the abutment surface 189 and free end 375, pressing the valve member 380 in a downwards direction, and thereby disengaging and unsealing the inlet port sealing member 395 from the lower valve port 165.

The weight of the float member 180 is chosen such as to be capable of overcoming the buoyancy and spring forces acting on the valve member 380, while at the same time the volume and/or configuration of the float member 180 is sufficient to provide a density that is less than the density of the liquid phase of the working fluid WF.

The second valve arrangement 300 further comprises valve outlet port arrangement 310 which in operation of the valve 100 is always in open fluid communication with the chamber 11, in particular the liquid phase working fluid WF below liquid level LV and thus below headspace HS. While in at least this example the valve outlet port arrangement 310 comprises a plurality of outlet ports 310A formed in bottom wall 390, in alterative variations of this example the valve outlet port arrangement 310 additionally or alternatively comprises one or more outlet ports formed on side wall 391. In yet other alterative variations of this example the valve outlet port arrangement 310 additionally or alternatively comprises a single outlet port, formed on one or more of side wall 391 and bottom wall 390.

In operation of the valve 100, fluid, in particular liquid phase of the working fluid WF, can pass from the chamber 11, in particular from below the liquid level LV or from below headspace HS, through the second valve arrangement 300, in particular via the inlet port 165 and the valve outlet port arrangement 310, i.e., along flow path B, only when the inlet port sealing member 395 is not in sealing engagement with the inlet port 165.

It is therefore readily appreciated that the float member 180, in particular the lower float member 182, is part of the first valve arrangement 200, and also part of the second valve arrangement 300.

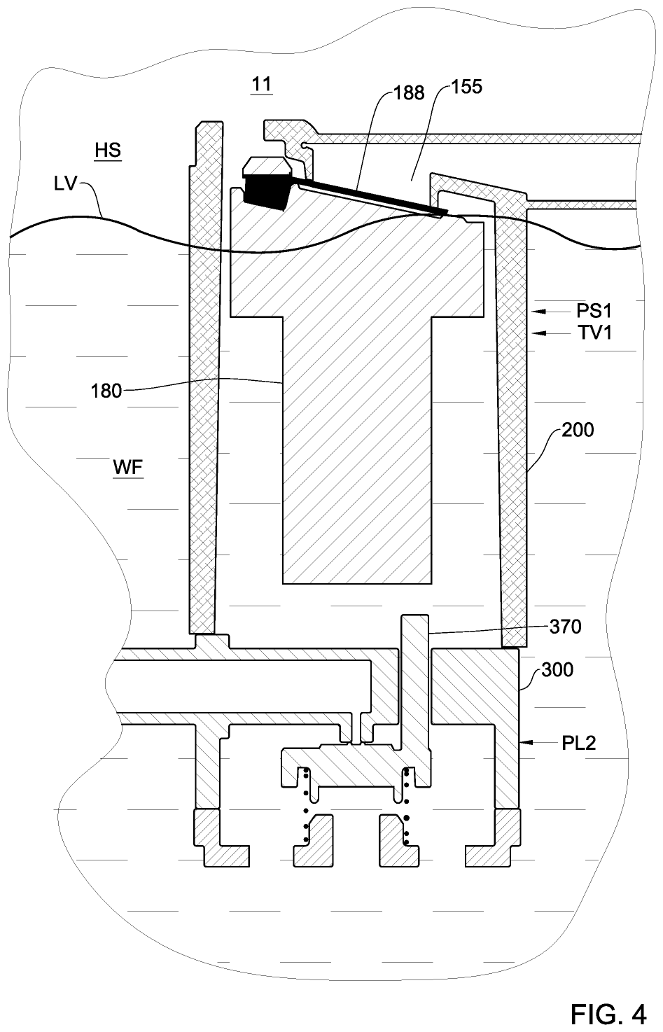

Referring to FIGS. 4, 5 and 6, the valve 100 has at least three operating modes, respectively: flooded mode, venting mode, and venting/fill mode.

Referring in particular to FIG. 4, in flooded mode, the liquid level LV is at or higher than the first threshold value TV1. The buoyancy forces acting on the lower float member 182 and on the float member 180 tend to press the membrane strip 188 into sealing engagement with the upper valve port 155. Accordingly, fluid communication between the headspace HS and the upper valve port 155 is prevented, and thus the valve 100 prevents flow of vapor phase of the working fluid WF to the cooling recirculation circuit 52 or 52′.

Concurrently, since the liquid level LV is at or higher than the first threshold value TV1, and thus the float member 180 is at the first float position PS1, the float member 180 is not in abutting contact with the rod member 370, and thus the second valve arrangement 300 remains closed, preventing flow of liquid phase of the working fluid WF into the chamber 11 via the lower valve port 165 from the cooling recirculation circuit 52 or 52′.

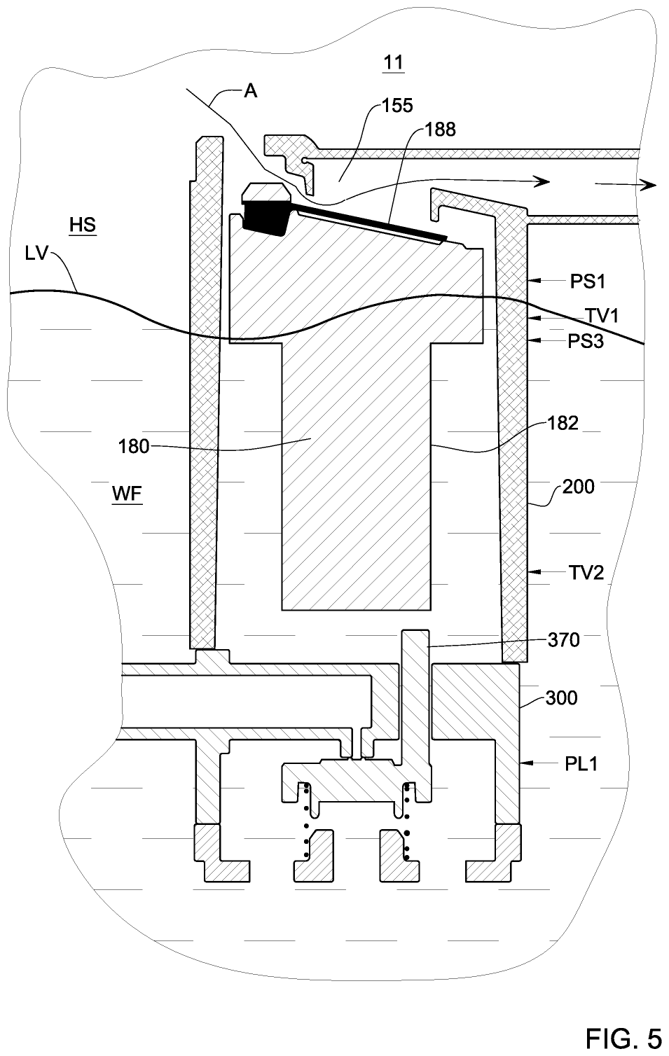

Referring in particular to FIG. 5, in venting mode, the liquid level LV is at a particular intermediate float position PS3 below the first threshold value TV1 but above the second threshold value TV2. As the level of liquid LV drops, the float member 180 (and thus the lower float member 182) are carried by the liquid level LV away from the upper valve port 155, thereby progressively unsealing and disengaging the membrane strip 188 with respect to the upper valve port 155. Accordingly, fluid communication between the headspace HS and the upper valve port 155 is now allowed, and thus the valve 100 enables flow of vapor phase of the working fluid WF to the cooling recirculation circuit 52 or 52′.

Concurrently, since the liquid level LV is still higher than the second threshold value TV1, the float member 180 is at an intermediate float position PS3 such that the float member 180 is not in abutting contact with the rod member 370, and thus the second valve arrangement 300 remains closed, preventing flow of liquid phase of the working fluid WF into the chamber 11 via the lower valve port 165 from the cooling recirculation circuit 52 or 52′.

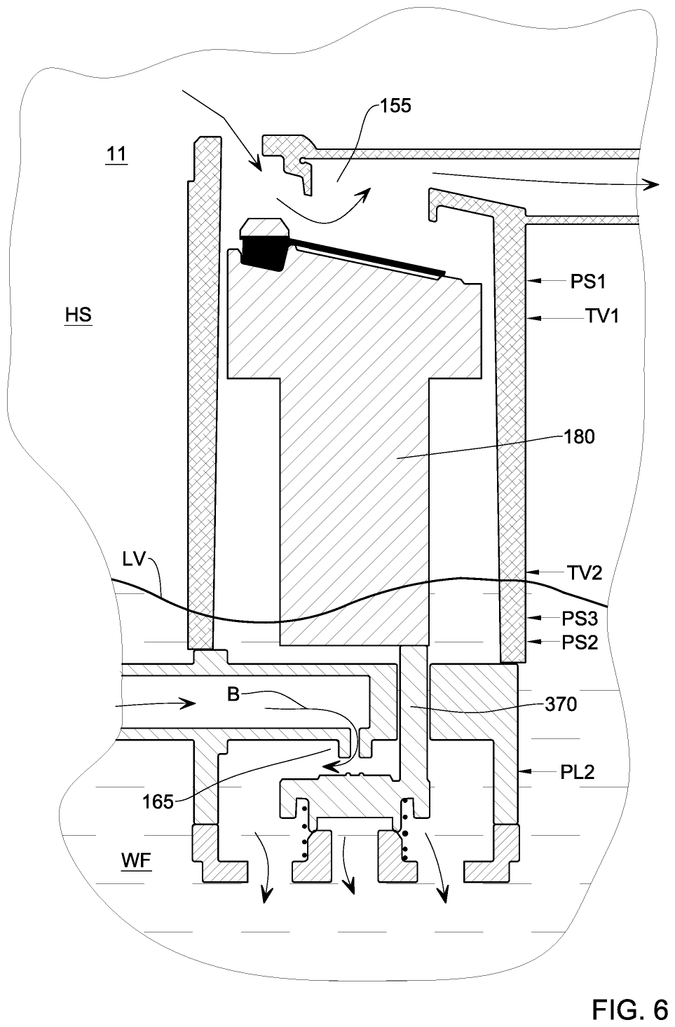

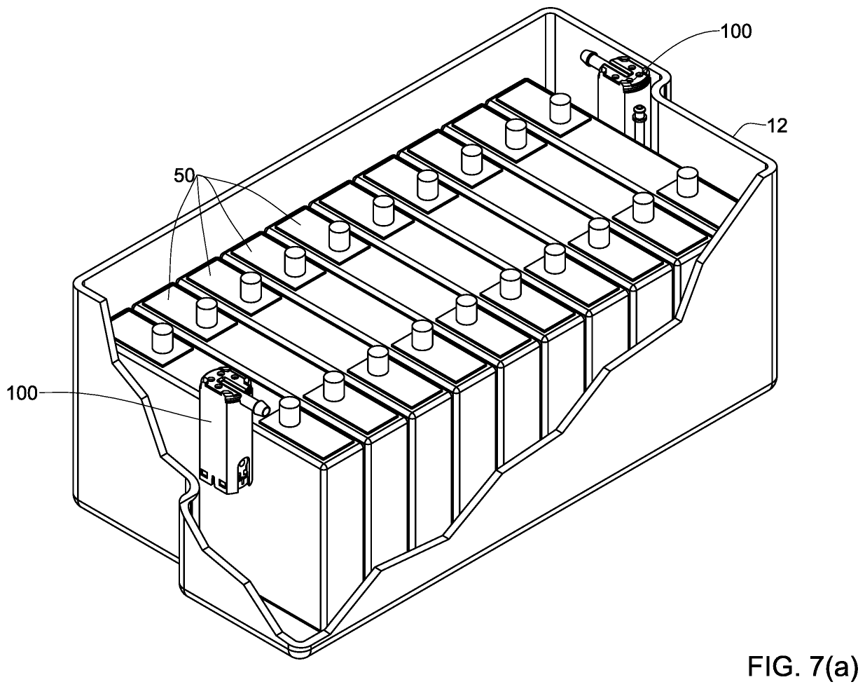

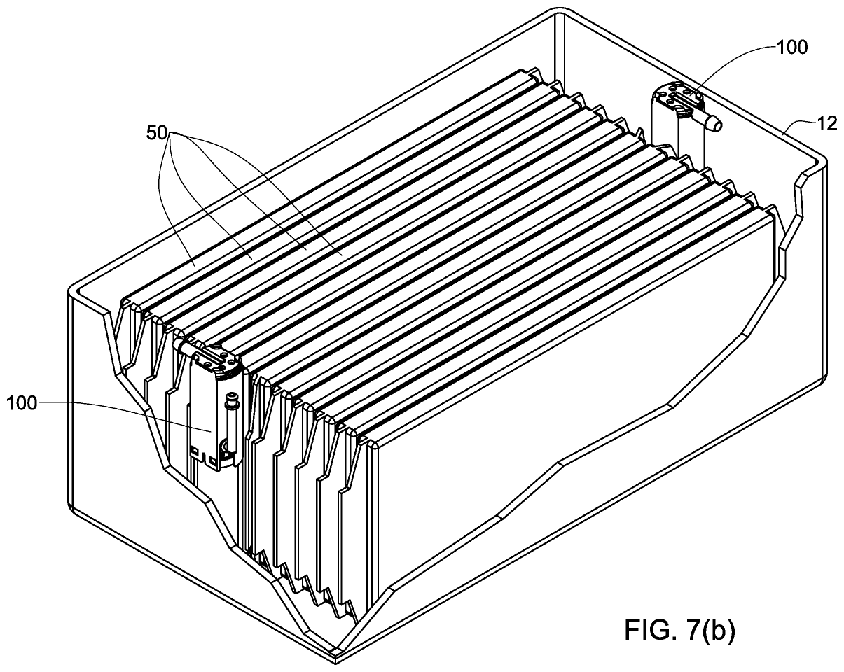

Referring in particular to FIG. 6, in venting/fill mode (also interchangeably referred to herein as “venting and fill mode”), the liquid level LV is at a particular intermediate float position PS3 below the second threshold value TV2, and thus also well below the first threshold value TV1. At this point, the float member 180 (and thus the lower float member 182) are carried by the liquid level LV away from the upper valve port 155 sufficiently to fully disengage the membrane strip 188 with respect to the upper valve port 155. Accordingly, fluid communication between the headspace HS and the upper valve port 155 is now at a maximum, and thus the valve 100 enables full flow of vapor phase of the working fluid WF to the cooling recirculation circuit 52 or 52′.

Concurrently, since the liquid level LV is now lower than the second threshold value TV2, the float member 180 is at or close to a corresponding intermediate float position PS3, in which the float member 180 is in abutting contact with the rod member 370, and in which the float member 180 is furthermore pressing the valve member 380 away from the lower valve port 165. In this manner the second valve arrangement 300 is opened, allowing flow of liquid phase of the working fluid WF into the chamber 11 via the lower valve port 165 from the cooling recirculation circuit 52 or 52′, thereby enabling the chamber 11 to be filled with liquid phase of the working fluid WF.

As the filling process continues, the liquid level LV of working fluid WF in the chamber 11 raises to the second threshold value TV2, the float member 180 presses less and less on the rod element 370, enabling the valve member 380 to sealing abut the lower valve port 165 at this level, thereby shutting off the second valve arrangement 300.

In the above example, the longitudinal axis LA2 of the first valve arrangement 200 is coaxial with the longitudinal axis LA3 of the second valve arrangement 300. Furthermore, in the above example the first valve arrangement 200 and the second valve arrangement 300 are in vertical stacked relationship, in which the first valve arrangement 200 is vertically above the second valve arrangement 300.

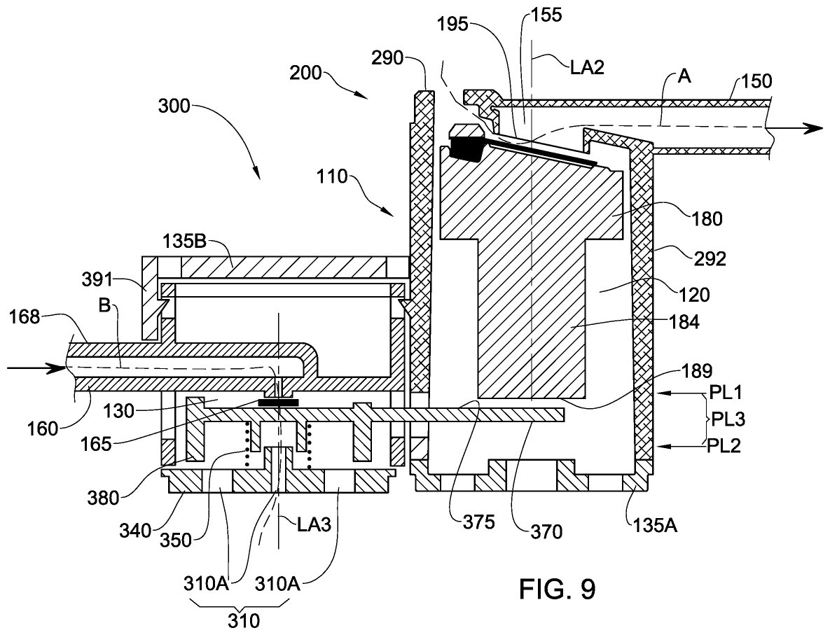

However, in at least some alternative variations of this example, the longitudinal axis LA2 of the first valve arrangement 200 is non-coaxial with the longitudinal axis LA3 of the second valve arrangement 300. For example, and referring to FIG. 9, in one such example the longitudinal axes LA2 and LA3 can be parallel but laterally displaced from one another, such that the first valve arrangement 200 and the second valve arrangement 300 are in lateral stacked relationship, in which the first valve arrangement 200 is laterally adjacent to the second valve arrangement 300.

Thus, the two-phase valve of the example of FIG. 9 has all the features and elements of the two-phase valve of the example of FIG. 3, as disclosed herein but with the following differences, mutatis mutandis.

A first such difference is that in the example of FIG. 9, the partition wall 135 of the example of FIG. 1 is divided into two separate walls—first wall 135A, and second wall 135B, such that the respective valve housing 110 in the example of FIG. 9 comprises:
upper wall 290, upper side wall 292, and first wall 135A defining the first chamber 120; and
lower side wall 391 and bottom wall 390, and second wall 135 defining the second chamber 130.

A second such difference is that in the example of FIG. 9, the actuation member, in the form of rod element 370 of the example of FIG. 3 also has a free end 375 that projects into the first valve chamber 120 and is configured for receiving an external actuation force selectively provided by the float member 180. Also in the example of FIG. 9, the free end 375 is configured for abutting the lower end of the float 180, in particular the lower end of the second float portion 184, more in particular the abutment zone 189. However, in the example of FIG. 9, the rod element 370, in particular the free end 375 thereof, projects into the first valve chamber 120 in a generally lateral direction, via apertures 125A, 125B formed in the side walls 391 and 292 respectively, rather than aperture 125 formed in partition wall 135 in the example of FIG. 3. Such abutment occurs in a similar manner to that disclosed herein for the example of FIG. 3, mutatis mutandis, i.e., under predetermined conditions, where the float 180, in particular the second float portion 184 descends as the level of liquid LV descends to below a second threshold value TV2. In at least this example this example of FIG. 9, the vertical dimension of the valve 100 can be made smaller than that of the valve of the example of FIG. 3, which can be useful for example in examples in which there is limited vertical space in the battery module 10.

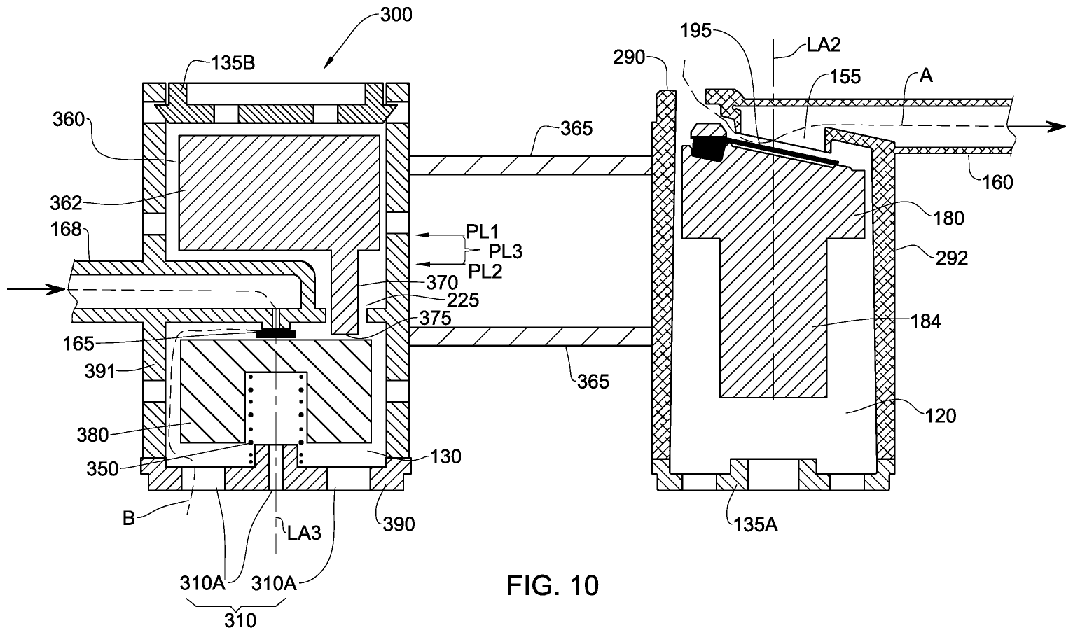

In at least some other alternative variations of the above examples, the longitudinal axis LA2 of the first valve arrangement 200 is also non-coaxial with the longitudinal axis LA3 of the second valve arrangement 300, in particular parallel but laterally displaced from one another, but wherein the first valve arrangement 200 and the second valve arrangement 300 operate essentially independent from one another. For example, and referring to FIG. 10, the first valve arrangement 200 and the second valve arrangement 300 are in lateral stacked relationship, in which the first valve arrangement 200 is laterally adjacent to the second valve arrangement 300, similar to the arrangement of the example of FIG. 9, mutatis mutandis.

Thus, the two-phase valve of the example of FIG. 10 has all the features and elements of the two-phase valve of the example of FIG. 3 or of the example of FIG. 9, as disclosed herein but with the following differences, mutatis mutandis.

A first such difference with respect to the example of FIG. 3, and in a similar manner to the example of FIG. 9, mutatis mutandis, in the example of FIG. 9, the partition wall 135 of the example of FIG. 1 is divided into two separate walls—first wall 135A, and second wall 135B, such that the respective valve housing 110 in the example of FIG. 9 comprises:
upper wall 290, upper side wall 292, and first wall 135A defining the first chamber 120; and
lower side wall 391 and bottom wall 390, and second wall 135 defining the second chamber 130.

A second such difference is that in the example of FIG. 10, the respective two-phase valve, in particular the second valve arrangement 300, comprises an additional chamber 360 above the second chamber 120. The additional chamber 360 comprises a second valve float member 362, reciprocably movable within the chamber 362, and similar to float member 180, mutatis mutandis, but with the main difference that the second valve float member 362 is configured only for pressing on the respective rod member 370 in conditions corresponding to vent/fill mode. In FIG. 10, the respective actuation member, also in the form of a rod element 370. However, while in the example illustrated example, the respective rod element 370 is illustrated as projecting from the second float member 362 towards the valve member 380, in alternative variations of this example the respective rod element 370 can instead project from the valve member 380 towards the second float member 362; in yet other alternative variations of the example of FIG. 10, the respective two-phase valve can comprise two actuation elements, one projecting from the second float member 362 towards the valve member 380, and the other projecting from the valve member 380 towards the second float member 180, each through one or more apertures 225 provided in partition wall 235 between the second chamber 130 and additional chamber 360.

Thus, in the example of FIG. 10, the respective first valve arrangement 200 and the second valve arrangement 300 can be provided as separate devices, which can also operate independently of one another, and the separate devices can be joined to one another (for example via couplers 365), or separately installed in the battery module 10.

It is to be noted that in the example of FIG. 10, the relative positions between the second float member 362 and the first float member 180 are such as to ensure that the first float member 180 sealingly engages the outlet port 155 when the first float member 180 is floating on a liquid level LV not below the first threshold value, and such that the second float member 362 and the respective valve member 380 are in mutually abutting contact when the liquid level LV is at the second threshold value TV2, and such that as the liquid level reduces from the second threshold value TV2 the second valve arrangement 300 opens.

Thus, operation of the example of the valve of FIG. 9 and of the example of the valve of FIG. 10 is similar to that of the example of FIG. 3, and disclosed herein (in particular referring to FIGS. 4, 5 and 6, regarding the at least three operating modes, respectively: flooded mode, venting mode, and venting/fill mode), mutatis mutandis.

Referring to FIG. 11, FIG. 11(a) and FIG. 11(b), a two phase valve according to a second example of the presently disclosed subject matter, generally designated with reference numeral 1100, comprises an first valve arrangement 1200 and a second valve arrangement 1300.

While also in at least this example the first valve arrangement 1200 and the second valve arrangement 1300 are integrated in a unitary device, in alternative variations of this example, the first valve arrangement 1200 and the second valve arrangement 1300 can be provided as separate devices, which can also operate independently of one another.

It is also to be noted that in yet other alternative variations of this example, alternative configurations can be provided for the first valve arrangement.

In any case, the valve 1100 is configured for ensuring the following, in a similar manner to the first example, mutatis mutandis:
that liquid phase of the working fluid WF is prevented from recirculating to the condenser 59 (or 59′) via the respective vapor phase line 54 (or 54′);
that only vapor phase of the working fluid WF selectively recirculates to the condenser 59 (or 59′) via the respective vapor phase line 54 (or 54′), when the liquid level LV therein drops below a respective first threshold value TV1;
that liquid phase of working fluid WF is selectively ingressed into the chamber 11 only when the liquid level LV therein drops below a respective second threshold value TV2;
that vapor phase of the working liquid WL is prevented from recirculating to the condenser 59 (or 59′) via the respective vapor phase line 54 (or 54′) when the chamber 11 is flooded (over-full).

The valve 1100 comprises a valve housing 1110 (also interchangeably referred to herein as a valve body) configured for being at least partially immersed in the liquid phase of the working fluid WF. The valve housing 1110 defines a first chamber 1120 associated with the first valve arrangement 1200, and a second chamber 1130 associated with the second valve arrangement 1300.

In at least this example, the first chamber 1120 and the second chamber 1130 are in vertical stacked relationship. Furthermore, in at least this example, the first chamber 1120 and the second chamber 1130 are in open fluid communication with one another.

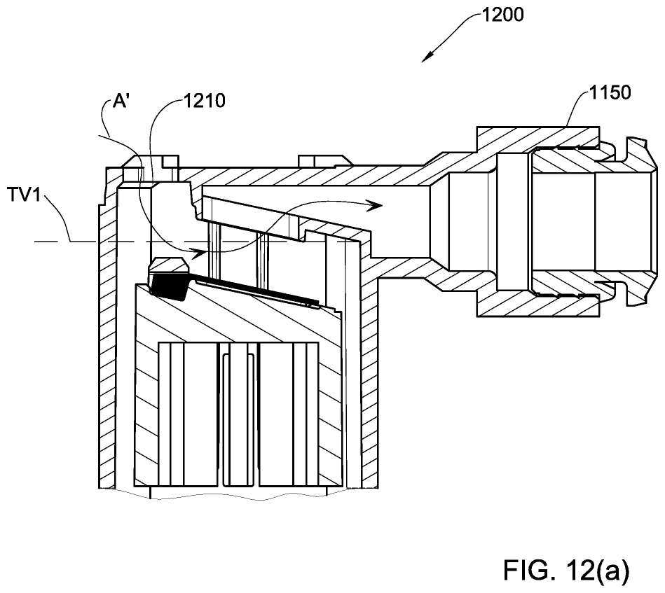

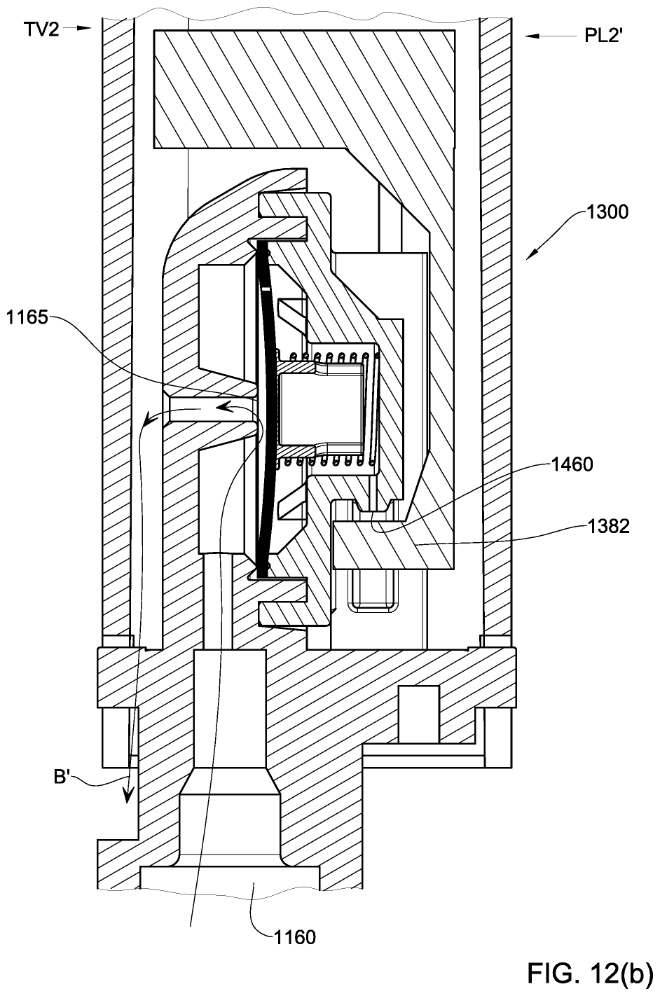

As will become clearer herein, and referring in particular to FIG. 12(a), the first valve arrangement 1200 defines a respective first flow path A′ for enabling venting vapor phase of the working fluid WF to vent therethrough when the first valve arrangement 1200 is open, the first valve arrangement 1200 being configured for selectively closing said flow path A′ when a liquid level LV of said liquid phase of said working fluid WF is not less than a respective first threshold value TV1.

Also as will become clearer herein, and referring in particular to FIG. 12(b), the second valve arrangement 1300 defines a second flow path B′ for enabling passage of said liquid phase of the working fluid WF therethrough when the second valve arrangement 1300 is open, the second valve arrangement 1300 being configured for selectively closing said second flow path B′ when a liquid level LV of said liquid phase of said working fluid WF is not less than a respective second threshold value TV2. According to this aspect of the presently disclosed subject matter, the second threshold value TV2 is lower than said first threshold value TV1.

In at least this example the valve housing 1110 comprises an upper wall 1290, upper side wall 1292, defining the first chamber 1120. Also in at least this example the valve housing 1110 also comprises a lower side wall 1391 and bottom wall 1390, which define the second chamber 1130.

Furthermore, in at least this example, the upper side wall 1292 and the lower side wall 1391 are contiguous with one another.

The valve housing 1110 is configured for being fixedly mounted with respect to the battery module 10.

It is to be noted that valve housing 1110 is configured for allowing liquid phase of the working fluid to readily enter and leave the first chamber 1120 and the second chamber 1130, such that the level of liquid phase of the working fluid inside the valve 1100, in particular inside the valve housing 1110, as well as in the liquid level in the first chamber 1120 and/or the second chamber 1130 corresponds to the liquid level LV in chamber 11.

Also as in the first example, mutatis mutandis, in the second example the valve 1100 comprises a vapor phase outlet port 1150 configured for being coupled to the outlet port 15, and a liquid phase inlet port 1160 configured for being coupled to inlet port 16.

Referring in particular to FIG. 11 and FIG. 11(a), The vapor phase outlet port 1150 is in fluid communication with an upper valve port (also interchangeably referred to herein as outlet port) 1155 via outlet conduit 1158. In at least this example, the outlet conduit 1158 is in the form of a tube extending generally laterally with respect to the longitudinal axis LA2′ of the first valve arrangement 1200.

The first valve arrangement 1200 comprises a first float member 1180 accommodated in first chamber 1120. The first float member 1180 is reciprocally movable (along the longitudinal axis LA2′) within the first chamber 1120 between an uppermost position PS1′ and a lowermost position PS2′, defining a plurality of intermediate positions PS3′ intermediate between the uppermost position PS1′ and the lowermost position PS2′, as will become clearer herein.

The first float member 1180 comprises a lateral projection 1181 that abuts a mechanical stop 1281 provided by the lower side wall 1391, limiting displacement of the first float member 1180 in a downward direction to lowermost position PS2′.

In at least this example, the first float member 1180 has a density less than the density of the working fluid WF, and is thus configured for floating on such a working fluid WF. For example, the first float member 1180 comprises a cavity 1184 enclosing a pocket of gas. Additionally or alternatively, the first float member 1180 can be made from a material having a density less than the density of the working fluid WF.

For example, the working fluid can have a specific gravity of 1.28, while the first float member 1180 (including the pocket of gas) can have a specific gravity of less than 1.28, for example 1.1.

For example, the first float member 1180 can be made from Nylon, and the working fluid WF is HTF-24, provided by Versatill.

The first float member 1180 comprises an outlet port sealing member 1195 at an upper end thereof. The outlet port sealing member 1195 is configured for selectively sealing the upper valve port 1155, as will become clearer herein.

In at least this example, the first float member 1180 is formed at an upper end thereof with an inclined top wall portion 1186 fitted with the outlet port sealing member 1195, which in this example is in the form of an elongated flexible closure membrane strip 1188. The elongated flexible closure membrane strip 1188 is anchored at one end 1190 thereof to an upper part of the top surface of the first float member 1180 and the other end 1192 of the closure membrane strip 1188 is free.

In at least this example, the upper valve port 1155 is in the form of a slit-like aperture inclined with respect to a longitudinal axis LA2′, generally complementary to the inclination of wall portion 1186.

It should be readily understood that when the valve 1100 is at least partially immersed in the liquid phase of working fluid WF, such that the liquid level LV (both inside the valve 1100 and outside thereof in chamber 11) is at or higher than a threshold value TV1, the buoyancy forces acting on the first float member 1180 tend to press the membrane strip 1188 into sealing engagement with the outlet port 1155. On the other hand, at liquid levels LV lower than the threshold value TV1 gravity forces acting on the first float member 1180 tend to displace the first float member 1180 away from the outlet port 1155 as the first float member 1180 floats on a descending liquid level, so as to progressively detach the strip membrane 1188 from sealing engagement with the outlet port 1155.

It is to be noted that in at least this example there is an absence of a spring otherwise biasing the first float member 1180 in an upward direction towards the upper valve port 1155. In this case, the weight of first float member 1180 acts in a downward direction while the buoyancy force (which depends on the volume of the first float member 1180) acts in an upward direction, and thus there is a net upward force, corresponding to the vector sum of the weight and buoyancy forces acting on the first float member 1180, when the liquid level LV is at the first threshold value TV1, and a net downward force when the liquid level LV has dropped such that the first float member 1180 is no longer floating on the liquid, for example at second threshold value TV2.

However, in alternative variations of this example, a suitable spring can be provided to bias the first float member 1180 towards or away from the upper valve port 1155, and further optionally the first float member 1180 can have an overall density that is equal to or greater than the density of the liquid phase of the working fluid WF. In one such a case in which the spring biases the first float member towards the upper valve port 1155, the weight of first float member 1180 acts in a downward direction while the buoyancy force (which depends on the volume of the first float member 1180) plus the spring force act in an upward direction, and thus there is a net upward force, corresponding to the vector sum of the weight force, the buoyancy force and the spring force acting on the first float member 1180, when the liquid level LV is at the first threshold value TV1, and a net downward force when the liquid level LV has dropped such that the first float member 1180 is no longer floating on the liquid, for example at second threshold value TV2.

In at least this example, it is ensured that first float member 1180 is axially aligned within the valve housing 1110, and in particular the first chamber 1120, and that first float member 1180 does not rotate within the first chamber 1120 about the longitudinal axis LA2′, thereby ensuring proper sealing of outlet port 1155. For this purpose, the first chamber 1120 and the first float member 1180 can be provided with a suitable alignment arrangement, for example mating radially projecting ribs (not shown), to prevent such rotation.

It is to be noted that in alternative variations of this example, the upper valve port 1155 and the outlet port sealing member 1195 can have different configurations from those illustrated in FIGS. 11 and 11(a). It is to be noted that also in these alternative examples, the buoyancy forces acting on the first float member 1180 tend to press the respective outlet port sealing member 1195 into sealing engagement with the outlet port 1155, whilst gravity forces acting on the first float member 1180 tend to displace the first float member 1180 away from the outlet port 1155. Thus, in the example of FIGS. 11, 11(a), 11(b) and in the above-mentioned other alternative variations thereof, as the level of fluid LV with respect to the valve 1100 lowers, the first float member 1180 also displaces in a downward direction with respect to the chamber 1120 thereby disengaging the outlet port sealing member 1195 from sealing engagement with the outlet port 1155 as the first float member 1180 floats on a descending liquid level.

The first valve arrangement 1200 further comprises a valve inlet port arrangement 1210 which in operation of the valve 1100 is always in open fluid communication with the chamber 11, in particular the headspace HS. While in at least this example the valve inlet port arrangement 1210 comprises a single inlet port 1210A formed in the upper wall 1290, and a single inlet port 1210A formed in the side wall 1292 in alterative variations of this example the valve inlet port arrangement 1210 alternatively comprises a plurality of inlet ports 1210A provided in upper wall 1290 and/or plurality of inlet ports 1210A provided in side wall 1292. In yet other alterative variations of this example the valve inlet port arrangement 1210 comprises one or more inlet ports 1210A formed only on upper wall 1290, or, one or more inlet ports 1210A formed only on upper side wall 1292.

In operation of the valve 1100, fluid, in particular vapor phase of the working fluid WF, can pass from the chamber 11, in particular from the headspace HS, through the first valve arrangement 1200, in particular via the valve inlet port arrangement 1210 and the outlet port 1155, i.e., along flow path A′, only when the outlet port sealing member 1195 is not in full sealing engagement with the outlet port 1155.

Referring in particular to FIG. 11 and FIG. 11(b), the liquid phase inlet port 1160 is in fluid communication with a lower valve port (also interchangeably referred to herein as inlet port) 1165 via inlet conduit 1168. In at least this example, the inlet conduit 1168 is in the form of a tube extending generally parallel with respect to the longitudinal axis LA3′ of the second valve arrangement 1300.

The second valve arrangement 1300 further comprises valve outlet port arrangement 1310 which in operation of the valve 1100 is always in open fluid communication with the chamber 11, in particular the liquid phase working fluid WF below liquid level LV and thus below headspace HS. While in at least this example the valve outlet port arrangement 1310 comprises a single outlet port 1310A formed in bottom wall 1390, in alterative variations of this example the valve outlet port arrangement 1310 additionally or alternatively comprises one or more outlet ports formed on side wall 1391. In yet other alterative variations of this example the valve outlet port arrangement 1310 additionally or alternatively comprises a plurality of outlet ports 1310A, formed on one or more of side wall 1391 and bottom wall 1390.

The second valve arrangement 1300 comprises a second float member 1380 accommodated in second chamber 1130. The second float member 1380 is reciprocally movable within the second chamber 1130 between an uppermost position PL1′ and a lowermost position PL2′, defining a plurality of intermediate positions PL3′ intermediate between the uppermost position PL1′ and the lowermost position PL2′, as will become clearer herein.

The second float member 1380 in this example has a density less than the density of the working fluid WF, and is thus configured for floating on such a working fluid WF.

The second float member 1380 is rigidly connected to a pilot orifice sealing member 1382, spaced below the second float member 1380 via a rod element 1370. The rod element 1370 projects downward from the second float member 1380 at a lateral side hereof, such that the float unit 1381, comprising the second float member 1380, rod element 1370, and pilot orifice sealing member 1382 are in the form of a ″C: when viewed from the side as in FIG. 11(b). In operation of the second valve arrangement, the float unit 1381 is reciprocally movable within the second chamber 1130.

The second valve arrangement 1300 further comprises a valve unit 1400 coupled with the float unit 1381, and configured for selectively allowing or blocking fluid flow between liquid phase inlet port 1160 and valve outlet port arrangement 1310.

The valve unit 1400 comprises a valve unit housing 1410 affixed to the valve housing 1110. The valve unit housing 1410 comprises a first housing portion 1412 and a second housing portion 1414. The valve unit housing 1410 accommodates therein a diaphragm member 1450, clamped at the periphery 1452 thereof between the first housing portion 1412 and the second housing portion 1414.

A central portion 1451 of the diaphragm member 1450 is movable along a valve unit axis VA orthogonal with respect to a longitudinal axis LA3′ of the second valve arrangement 1300, under certain conditions, as will become clearer herein.

The first housing portion 1412 is affixed to the bottom wall 1390, in this example in an integral manner, and includes a first valve unit chamber 1411 in open fluid communication with inlet conduit 1168 and with liquid phase inlet port 1160. The first valve unit chamber 1411 accommodates therein the lower valve port 1165, which projects towards the diaphragm member 1450 from the first housing portion 1412.

The diaphragm member 1450 is configured for selectively sealing the lower valve port 1165, via a first diaphragm face 1450a, as will become clearer herein.

In at least this example, the lower valve port 1165 is in the form of a circular aperture having a central axis co-axial with valve unit axis VA, and has an annular periphery, sealable with respect to diaphragm member 1450.

The second housing portion 1414 includes a second valve unit chamber 1413 accommodating a diaphragm biasing arrangement 1356. The diaphragm biasing arrangement 1356 comprises spring 1350 and piston member 1355. The spring 1350 has one longitudinal end thereof anchored in the second housing portion 1414, and an opposed longitudinal end thereof affixed to the piston member 1355. The piston member 1355 abuts the second diaphragm face 1450b, and the spring 1350 biases the diaphragm member 1450 against the lower valve port 1165 via piston member 1355.

The diaphragm member 1450 comprises a diaphragm aperture 1459 providing fluid communication between the first valve unit chamber 1411 and the second valve unit chamber 1413.

The second housing portion 1414 comprises a pilot lumen 1465 providing fluid communication between the second valve unit chamber 1413 and a pilot orifice 1460. The pilot orifice 1460 is reversibly sealable by pilot orifice sealing member 1382. When the float unit 1381 is at uppermost position PL1′, the pilot orifice sealing member 1382 sealingly abuts pilot orifice 1460; when the float unit 1381 is below uppermost position PL1′, in particular when the float unit 1381 is at the lowermost position PL2′, the pilot orifice sealing member 1382 is spaced from pilot orifice 1460, providing fluid communication between the second valve unit chamber 1413 and the second chamber 1130.

In at least this example, the pilot orifice 1460 and the pilot lumen 1465 are each, in general, as small as possible, consistent with enabling flow of the liquid phase of the working fluid WF therethrough (when open). In at least this example, the pilot orifice 1460 has the same diameter than the pilot lumen 1465. For example, the pilot orifice 1460 and the pilot lumen 1465 can each have a diameter of between about 0.2 mm and about 0.3 mm. For example the pilot lumen 1465 can have a length of between about 3 mm and about 4 mm.

Furthermore, in at least this example, the diaphragm aperture 1459 is smaller than or equal in size with, the pilot orifice 1460. In at least this example, the diaphragm aperture 1459 is also smaller than or equal in size with, the pilot lumen 1465. For example, the diaphragm aperture 1459 has a diameter of, for example between about 0.1 mm and about 0.2 mm.

As shall become clearer herein, when the level of liquid phase working fluid WF is at or above the second threshold value TV2, the second float member 1380 is at its uppermost position PL1′, thereby sealingly engaging the pilot orifice sealing member 1382 against the pilot orifice 1460. This abutment of the pilot orifice sealing member 1382 against the pilot orifice 1460 also prevents the float unit 1381, in particular the second float member 1380, from being displaced in an upward direction past the uppermost position PL1′. Under these conditions the pilot orifice 1460 is sealingly closed by the pilot orifice sealing member 1382, and fluid pressures in the first valve unit chamber 1411 and the second valve unit chamber 1413 are equalized via the diaphragm aperture 1459, and the diaphragm biasing arrangement 1356 biases the diaphragm member 1450 into sealingly closed engagement against the lower valve port 1165. In this manner, the second valve arrangement 1300 closes fluid communication between the liquid phase inlet port 1160 of the valve 1100 and valve outlet port arrangement 1310, i.e., closing second flow path B′.

Conversely, and also as shall become clearer herein, as the level of liquid phase working fluid WF drops below the second threshold value TV2, the second float member 1380 is also displaced downwards together with the pilot orifice sealing member 1382, thereby disengaging and unsealing pilot orifice sealing member 1382 from the pilot orifice 1460. Under these conditions in which the pilot orifice 1460 is open with respect to the pilot orifice sealing member 1382, the first valve unit chamber 1411 can be at a relatively high pressure, being exposed to the liquid pressure of the liquid phase return line 56. Concurrently, the second valve unit chamber 1413 is at a relatively lower pressure, being exposed to the liquid pressure of the liquid phase working fluid WF via the open the pilot orifice 1460. Under such circumstances, a pressure difference exists between the first diaphragm face 1450a and the second diaphragm face 1450b, sufficient large to overcome the spring force of spring 1350. This in turn allows the diaphragm member 1450, in particular the central portion 1451 thereof, to move away from the lower valve port 1165 along a valve unit axis VA, thereby opening the lower valve port 1165 and allowing fluid communication between the liquid phase inlet port 1160 of the valve 1100 and valve outlet port arrangement 1310 via second flow path B′.

Thus, the float unit 1381 essentially operates as an actuation member for the valve unit 1400. The weight of the second float member 1380 is chosen such as to be capable of overcoming the buoyancy forces acting on pilot orifice sealing member 1382, while at the same time the volume and/or configuration of the second float member 1380 is sufficient to provide a density that is less than the density of the liquid phase of the working fluid WF.

It should be readily understood that by having the valve unit axis VA essentially horizontal, buoyancy forces and gravitational forces acting on the valve unit 1400 do not significantly influence operation of the valve unit 1400.

It should also be readily understood that in operation of the second valve arrangement 1300 the valve unit 1400 is always submerged in the liquid phase of the working fluid WF.

It should be readily understood that operation of the second valve arrangement 1300 is not mechanically coupled to the first valve arrangement 1200.

In operation of the valve 1100, fluid, in particular liquid phase of the working fluid WF, can pass from the chamber 11, in particular from below the liquid level LV or from below headspace HS, through the second valve arrangement 1300, in particular via the inlet port 1165 and the valve outlet port arrangement 1310, i.e., along flow path B′, only when the pilot orifice sealing member 1382 is not in sealing engagement with the pilot orifice 1460.

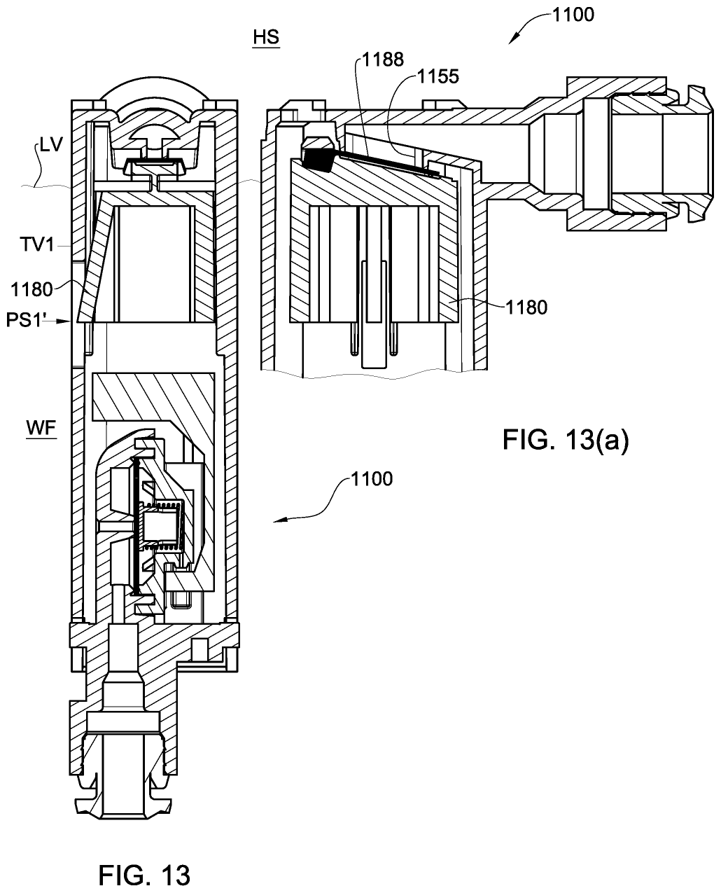

Referring to FIGS. 13 to 15(a), the valve 1100, in a similar manner to the first example mutatis mutandis, has at least three operating modes, respectively: flooded mode, venting mode, and venting/fill mode.

Referring in particular to FIG. 13 and FIG. 13(a), in flooded mode, the liquid level LV is at or higher than the first threshold value TV1, thus the first float member 1180 is at the first float position PS1′. The buoyancy forces acting on the first member 1180 tend to press the membrane strip 1188 into sealing engagement with the upper valve port 1155.

Accordingly, the first valve arrangement 1200 remains closed, fluid communication between the headspace HS and the upper valve port 1155 is prevented, and thus the valve 1100 prevents flow of vapor phase of the working fluid WF to the cooling recirculation circuit 52 or 52′.

Concurrently, since the liquid level LV is also higher than the second threshold value TV2, the second float member 1380 (and thus the float unit 1381) is the uppermost position PL1′, and thus the pilot orifice sealing member 1382 is in sealing engagement with the pilot orifice 1460. Thus, the second valve arrangement 1300 remains closed, preventing flow of liquid phase of the working fluid WF into the chamber 11 via the lower valve port 1165 from the cooling recirculation circuit 52 or 52′.

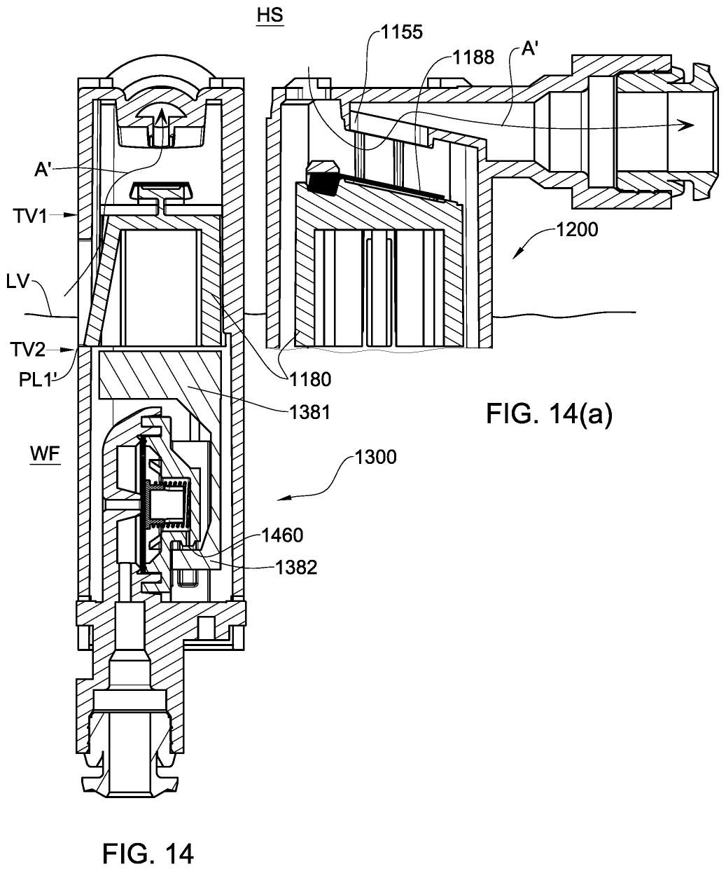

Referring in particular to FIGS. 14 and 14(a), in venting mode, the liquid level LV is at a position below the first threshold value TV1 but above the second threshold value TV2. As the level of liquid LV drops, the first float member 1180 are carried by the liquid level LV away from the upper valve port 1155, thereby progressively unsealing and disengaging the membrane strip 1188 with respect to the upper valve port 1155. Accordingly, the first valve arrangement 1200 opens, fluid communication between the headspace HS and the upper valve port 1155 is now allowed, and thus the valve 1100 enables flow of vapor phase of the working fluid WF to the cooling recirculation circuit 52 or 52′.

Concurrently, since the liquid level LV is still higher than the second threshold value TV2, the second float member 1380 (and thus the float unit 1381) is the uppermost position PL1′, and thus the pilot orifice sealing member 1382 is in sealing engagement with the pilot orifice 1460. Thus, the second valve arrangement 1300 remains closed, preventing flow of liquid phase of the working fluid WF into the chamber 11 via the lower valve port 1165 from the cooling recirculation circuit 52 or 52′.

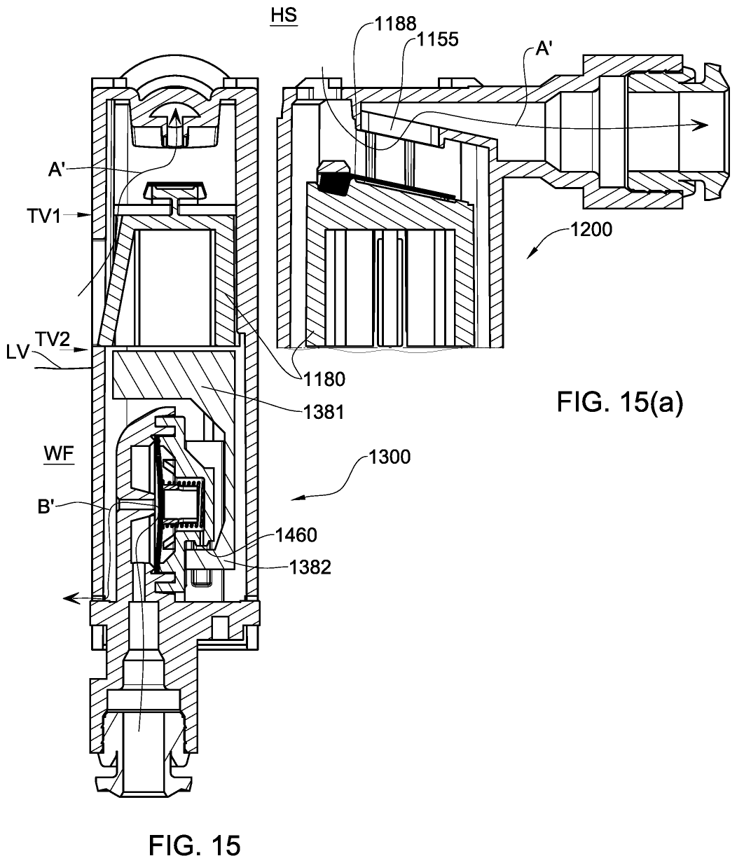

Referring in particular to FIG. 15 and FIG. 15(a), in venting/fill mode (also interchangeably referred to herein as “venting and fill mode”), the liquid level LV is below the first threshold value TV1 but also below the second threshold value TV2. At this point, the first float member 1180 is carried by the liquid level LV away from the upper valve port 1155, sufficiently to fully disengage the membrane strip 1188 with respect to the upper valve port 1155. Accordingly, the first valve arrangement 1200 opens, fluid communication between the headspace HS and the upper valve port 1155 is now at a maximum, and thus the valve 1100 enables flow of vapor phase of the working fluid WF to the cooling recirculation circuit 52 or 52′.

Concurrently, since the liquid level LV is now lower than the second threshold value TV2, the second float member 1380 (and thus the float unit 1381) is the lowermost position PL2′, and thus the pilot orifice sealing member 1382 is no longer in sealing engagement with the pilot orifice 1460. Thus, the second valve arrangement 1300 opens allowing flow of liquid phase of the working fluid WF into the chamber 11 via the lower valve port 1165 from the cooling recirculation circuit 52 or 52′, thereby enabling the chamber 11 to be filled with liquid phase of the working fluid WF.

As the filling process continues, the liquid level LV of working fluid WF in the chamber 11 raises to the second threshold value TV2, the first float member 180 presses less and less on the rod element 370, enabling the pilot orifice sealing member 1382 to sealing abut the pilot orifice 1460, which results in equalization of pressures on either side of the diaphragm member 1450, closing the lower valve port 1165, thereby shutting off the second valve arrangement 1300.

It is to be noted that in alternative variations of the above examples, the battery module 10 can comprise a valve pair, i.e.:
A. two such valves 100, according to the first example (or alternative variations thereof) of the presently disclosed subject matter, or
B. two such valves 1100 according to the second example of the presently disclosed subject matter, or
C. one valve 100, according to the first example (or alternative variations thereof) of the presently disclosed subject matter, plus one valve 1100 according to the second example of the presently disclosed subject matter.

While the following example, illustrated in FIGS. 7(a), 7(b) and 7(c), is disclosed in the context of option (A) above, it applies also to option (B) above, mutatis mutandis, and also to option (C) above, mutatis mutandis.

Thus, referring again to FIGS. 7(a), 7(b) and 7(c), each valve 100 of the aforesaid valve pair is independently connected to the recirculation circuit 50 (or 50′).

The two valves 100 can be located at opposite longitudinal ends of the battery module (with respect to the longitudinal direction of the vehicle in which it is intended to install the battery module 10. In such examples, the first threshold value TV1 for each of the valves 100 can be chosen such as to take into account uphill or downhill gradients of up to 20°, for example.

Assuming that the two valves 100 of the pair are at the same horizontal level when the vehicle is also on a horizontal plane, when the vehicle (and thus each valve 100 of this pair) is on an inclined surface, for example a gradient of 20°, one valve 100 will be at a higher vertical position than the other valve 100 of the pair. Accordingly, while the liquid level LV in the respective battery module 10 will of course be nominally horizontal, this liquid level LV of each of the two valves 100 of the pair (referred to herein as the respective local liquid level for each valve 100) will be different with respect to one another. In such a case, the valve 100 at the lower vertical position in such an inclined situation will be relatively more submerged than the other valve 100, which is at a relatively higher vertical position.

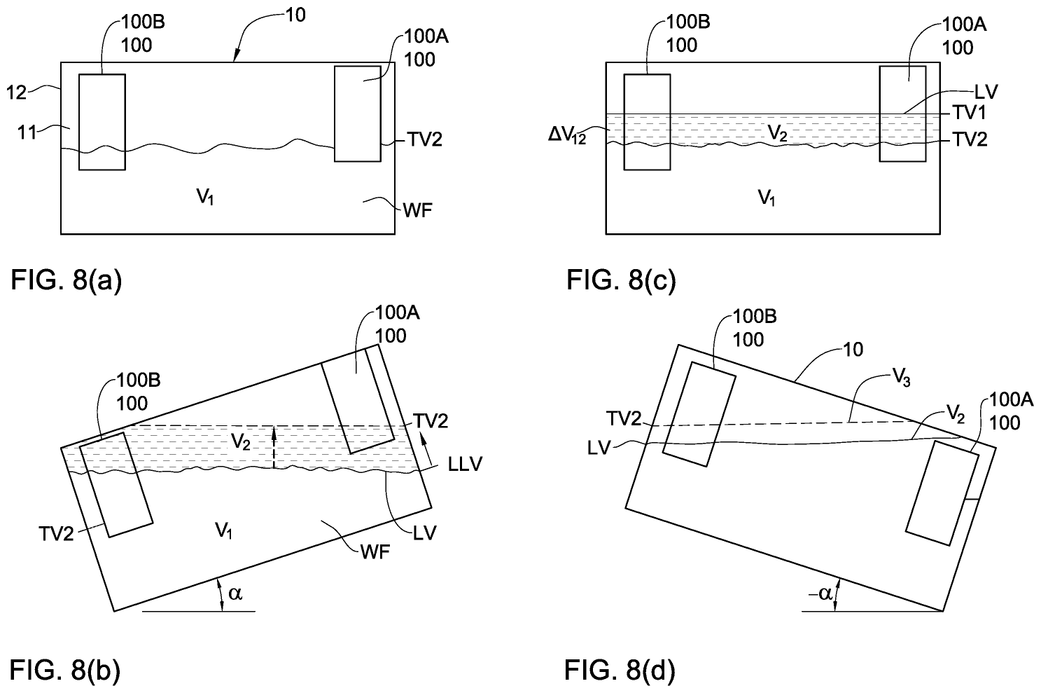

For facilitating comprehension of FIGS. 8(a) to 8(d), the two valves 100 of one such pair of valves 100 of a battery module shall also be designated as valve 100A at one longitudinal end of the battery module 10, and as valve 100B at the other longitudinal end of the battery module 10.

Referring to FIG. 8(a), the battery module 10 has a volume V1 of liquid phase working fluid WF such that when horizontal, the liquid level LV with respect to each of the two valves 100 (, i.e., valve 100A and valve 100B) is at the second threshold value TV2, and thus the second valve arrangement 300 of each valve 100 is closed, preventing any further liquid phase of the working fluid WF to enter the battery module 10.

Referring to FIG. 8(b), when the vehicle (and thus each valve 100 of this pair) is on an inclined surface, for example at angle α, for example a gradient of 20°, one valve 100 (valve 100A) will be at a higher vertical position than the other valve 100 (valve 100B) of the pair. The now-lower valve 100 (valve 100B) will experience a local liquid level LLV with respect to itself that is higher than the earlier liquid level LV when the vehicle was horizontal, and thus higher than its respective second threshold value TV2. However, the now-higher valve 100 (valve 100A) of the pair will experience a local liquid level LLV with respect to itself that is lower than the earlier liquid level when the vehicle was horizontal, and thus lower than its respective second threshold value TV2.

Accordingly, the second valve arrangement 300 of the now-lower valve 100 (valve 100B) will remain closed, while the second valve arrangement 300 of the now-higher valve 100 (valve 100A) will now open, since the local liquid level LLV is now less than the second threshold value TV2, and a volume AV12 of liquid phase of the working liquid WF will enter into the battery module 10 until the battery module 10 now holds a second volume V2 of liquid phase of the working fluid WF. This second volume V2 is such, that, at this vehicle inclination, the local liquid level LLV with respect to the now-higher valve 100 (valve 100A) reaches its respective second threshold value TV2. At this point, the second valve arrangement 300 of the now-higher valve 100 (valve 100A) will now close, thereby trapping within the battery module 10 the higher volume V2 of liquid phase of the working fluid WF.

Referring now to FIG. 8(c), when the vehicle returns to the horizontal position, this higher volume V2 of liquid phase of the working fluid WF will now provide a new liquid level LV higher than the previous liquid level LV, which was then at the second threshold value TV2 for one or both valves 100 of the pair.

Referring now to FIG. 8(d), if the vehicle is now tilted in the opposite direction (for example at angle-α, for example)−20°, the previously-lower valve 100 (valve 100B) will now be at a vertically higher position, and if the local liquid level LLV (at this higher volume V2) is at or higher than the second threshold value TV2 for this valve 100 (valve 100B), no more liquid phase of the working fluid WF will enter the battery module 10. In such a case volume V2 is the highest volume of liquid phase of the working fluid WF than can be accommodated in the battery module 10 when ingressed via the two valves 100.

However, if the local liquid level LLV (at this higher volume V2) is still lower than the second threshold value TV2 for this valve 100 (valve 100B), then its respective second valve arrangement 300 will now open and allow further liquid phase of the working fluid WF to enter the battery module 10 until the battery module 10 now holds a third volume of liquid phase of the working fluid WF. Thus, this third volume is such, that, at this vehicle inclination, the local liquid level LLV with respect to the previously-lower valve 100 (valve 100B) reaches its respective second threshold value TV2. At this point, the second valve arrangement 300 of the previously-lower valve 100 (valve 100B) will now close, thereby trapping within the battery module 10 the higher volume V3 of liquid phase of the working fluid WF. In such a case volume V3 is the highest volume of liquid phase of the working fluid WF than can be accommodated in the battery module when ingressed via the two valves 100.

The locations of the two valves 100 (valve 100A and valve 100B) of the pair in the battery module 10 can be chosen such that for a desired maximum inclination of ±a, say 20° in each direction, the maximum volume (V2 or V3) accommodated in the battery module 10 is such that at the horizontal position, the liquid level LV for the valves is at the first threshold value TV1.

It is to be noted that oscillatory movement of the battery module 10, for example as can be experienced when the vehicle can be travelling over a non-smooth surface, can also cause the local liquid level LLV to be different between the two valves 100 of the pair, and thus enable the volume of liquid phase of the working fluid WF to increase from volume V1 in a similar manner to being on an incline as discussed above, mutatis mutandis.

Finally, it should be noted that the word “comprising” as used throughout the appended claims is to be interpreted to mean “including but not limited to”.

While there has been shown and disclosed examples in accordance with the presently disclosed subject matter, it will be appreciated that many changes may be made therein without departing from the scope of the presently disclosed subject matter as set out in the claims.

1. A two-phase valve comprising a valve body configured for being at least partially immersible in a liquid phase of a working fluid, the valve body comprising:
a first valve arrangement, defining a first flow path for enabling venting vapor phase of the working fluid therethrough when the first valve arrangement is open, and wherein the first valve arrangement is configured for selectively closing said first flow path when said liquid phase of said working fluid has a liquid level not less than a first threshold value;
a second valve arrangement, defining a second flow path for enabling passage of said liquid phase of the working fluid therethrough when the second valve arrangement is open, and wherein the second valve arrangement is configured for selectively closing said second flow path when said liquid level of said liquid phase of said working fluid is not less than a second threshold value;
wherein said second threshold value is lower than said first threshold value.

2. The two-phase valve according to claim 1, wherein the valve housing defines a first chamber associated with the first valve arrangement, and a second chamber associated with the second valve arrangement.

3. The two-phase valve according to claim 2, wherein said valve housing comprises a valve inlet port arrangement and an outlet port defining said first flow path, and wherein the first valve arrangement comprises an outlet port sealing member configured for selectively being in full sealing engagement with respect to the outlet port providing a closed configuration for the first valve arrangement, and for being at least partially disengaged with respect to the outlet port providing an open configuration for the first valve arrangement.

4. The two-phase valve according to claim 3, wherein the first valve arrangement comprises a first float member accommodated in said first chamber, the first float member being reciprocally movable within the first chamber between a first valve uppermost position and a first valve lowermost position, defining a plurality of first valve intermediate positions intermediate between said first valve uppermost position and said first valve lowermost position, the first float member being configured for floating with respect to the liquid phase of the working fluid.

5. The two-phase valve according to claim 4, wherein said first float member has a density less than a density of the working fluid, and wherein said first float member is made from a material having a density less than the density of the working fluid.

6. The two-phase valve according to claim 4 or claim 5, wherein said first float member has a density less than a density of the working fluid, and wherein said first float member is at least partially hollow enclosing a pocket of gas.

7. The two-phase valve according to any one of claims 4 to 6, wherein
the first float member comprises an inclined top wall portion fitted with the outlet port sealing member, wherein the outlet port sealing member is in the form of an elongated flexible closure membrane strip having a first strip end a second strip end, wherein the elongated flexible closure membrane strip is anchored at said first strip end to an upper part of said top surface, and wherein said second strip end is free; and
the upper valve port is in the form of a slit-like aperture having an inclination generally complementary to an inclination of said top wall portion.

8. The two-phase valve according to any one of claims 4 to 7, having an absence of a spring otherwise biasing the first float member in a direction towards said outlet port.

9. The two-phase valve according to claim 8, wherein in operation of the first valve arrangement a net upward force is generated by the vector sum of a weight of the first float member and a buoyancy force acting on the first float member when the liquid level is at the first threshold value such as to ensure full sealing engagement between said outlet port sealing member and said outlet port.

10. The two-phase valve according to any one of claims 4 to 7, having a first spring otherwise biasing the first float member in a direction towards said outlet port.

11. The two-phase valve according to claim 10, wherein in operation of the first valve arrangement a net upward force is generated by the vector sum of a weight of the first float member, a spring force generated by the first spring, and a buoyancy force acting on the first float member when the liquid level is at the first threshold value such as to ensure full sealing engagement between said outlet port sealing member and said outlet port.

12. The two-phase valve according to any one of claims 2 to 11, wherein said valve housing comprises a valve outlet port arrangement and an inlet port defining said second flow path, and wherein the second valve arrangement comprises an inlet port sealing member configured for selectively being in full sealing engagement with respect to the inlet port providing a closed configuration for the second valve arrangement, and for being at least partially disengaged with respect to the inlet port providing an open configuration for the second valve arrangement.

13. The two-phase valve according to claim 12, wherein said second valve arrangement comprises a valve member accommodated in said second chamber, the valve member being reciprocally movable within the second chamber between a second valve uppermost position and a second valve lowermost position, defining a plurality of second valve intermediate positions intermediate between the second valve uppermost position and the second valve lowermost position.

14. The two-phase valve according to claim 13, wherein said second valve arrangement has a normally closed position.

15. The two-phase valve according to any one of claims 12 to 14, having a second spring otherwise biasing the valve member in a direction towards said inlet port.

16. The two-phase valve according to claim 15, wherein in operation of the second valve arrangement a net upward force is generated by the vector sum of a weight of the valve member, a second spring force generated by the second spring, and a second buoyancy force acting on the valve member when the liquid level is at least above the second threshold value such as to bias the inlet port sealing member to sealing engagement with respect to the inlet port.

17. The two-phase valve according to any one of claims 12 to 16, comprising a second float member configured for floating with respect to the liquid phase of the working fluid, and wherein the second valve arrangement is configured for opening said second fluid path responsive to an actuation force being applied thereto by the second float member, concurrent with the liquid level being less than said second threshold level.

18. The two-phase valve according to claim 17, wherein said second float member is unaffixed to said valve member.

19. The two-phase valve according to any one of claims 17 to 18, wherein at least one of said second float member and said valve member is configured such as to enable the second float member to apply said actuation force to said valve member when said liquid level is below said second threshold value, and to cease applying said actuation force when said liquid level is above said second threshold level.

20. The two-phase valve according to claim 19, comprising an actuation member affixed to one of said second float member and said valve member, the actuation member being abuttable with respect to the other one of said second float member and said valve member responsive to said liquid level being not greater than said second threshold value.

21. The two-phase valve according to claim 20, wherein said actuation member is in the form of rod element, projecting from the valve member towards the second float member.

22. The two-phase valve according to any one of claims 17 to 21, wherein said actuation force is a vector sum of a weight of the valve member and a buoyancy force of the valve member at said liquid level.

23. The two-phase valve according to claim 22, wherein said actuation force has a greater magnitude than said net upward force.

24. The two-phase valve according to any one of claims 2 to 23, wherein said first chamber and said second chamber are in vertical stacked relationship.

25. The two-phase valve according to claim 24, wherein said first float member comprises said second float member.

26. The two-phase valve according to claim 24, wherein said first float member and said second float member are one and the same float member.

27. The two-phase valve according to any one of claims 24 to 26, wherein said actuation member projects in a general vertical direction from the valve member.

28. The two-phase valve according to any one of claims 2 to 23, wherein said first chamber and said second chamber are in lateral stacked relationship.

29. The two-phase valve according to claim 28, wherein said first float member and said second float member are one and the same float member.

30. The two-phase valve according to any one of claims 27 to 29, wherein said actuation member projects in a general lateral direction from the valve member.

31. The two-phase valve according to claim 28, wherein said first float member is different from said second float member.

32. The two-phase valve according to claim 31, wherein said actuation member projects in a general vertical direction from the second float member.

33. The two-phase valve according to any one of claims 1 to 29, wherein operation of said first valve arrangement and said second valve arrangement is mechanically coupled.

34. The two-phase valve according to any one of claims 2 to 11, wherein said valve housing comprises a valve outlet port arrangement and an inlet port defining said second flow path, and wherein the second valve arrangement comprises a valve unit configured for selectively providing a closed configuration for the second valve arrangement, and for selectively providing an open configuration for the second valve arrangement.

35. The two-phase valve according to claim 34, wherein said second valve arrangement comprises a float unit coupled with said valve unit.

36. The two-phase valve according to claim 35, wherein said valve unit comprises a first valve unit chamber separated from a second valve unit chamber via a movable diaphragm member, wherein the diaphragm member comprises a diaphragm aperture providing fluid communication between the first valve unit chamber and the second valve unit chamber, wherein said first valve unit chamber in open fluid communication with said inlet port, and wherein said second valve unit chamber is in selective fluid communication with said second valve chamber via a pilot orifice coupled with said float unit.

37. The two-phase valve according to any one of claims 35 to 36, wherein said float unit is reversibly movable between an uppermost position and a lowermost position, wherein said uppermost position corresponds to said liquid level of said liquid phase of said working fluid being not less than said second threshold value, and wherein said lowermost position corresponds to said liquid level of said liquid phase of said working fluid being less than said second threshold value.

38. The two-phase valve according to claim 37, wherein said float unit is configured for closing fluid communication between said second valve chamber and said second valve via said pilot orifice when said float unit is in said uppermost position, and for opening fluid communication between said second valve chamber and said second valve via said pilot orifice when said float unit is in said lowermost position

39. The two-phase valve according to any one of claims 37 to 38, wherein said float unit comprises a second float member rigidly connected to a pilot orifice sealing member, spaced below the second float member via a rod element, wherein said pilot orifice sealing member is configured for sealingly closing said pilot orifice when said float unit is in said uppermost position, and for disengaging from said pilot orifice when said float unit is in said lowermost position.

40. The two-phase valve according to any one of claims 36 to 39, wherein said first valve unit chamber accommodates therein a lower valve port that projects towards the diaphragm member, wherein said lower valve port is in fluid communication with said valve outlet port arrangement.

41. The two-phase valve according to any one of claims 36 to 40, wherein said diaphragm member is configured for selectively sealing the lower valve port, to thereby close said second flow path responsive to said float unit being in said uppermost position, and wherein said diaphragm member is configured for selectively unsealing the lower valve port, to thereby open said second flow path responsive to said float unit being in said lowermost position.

42. The two-phase valve according to any one of claims 36 to 41, wherein said valve unit comprises a first housing portion and a second housing portion, wherein said diaphragm member is clamped between the first housing portion and the second housing portion.

43. The two-phase valve according to any one of claims 36 to 42, wherein a central portion of the diaphragm member is selectively movable along a valve unit axis orthogonal with respect to a longitudinal axis of the second valve arrangement.

44. The two-phase valve according to claim 43, wherein said second valve unit chamber accommodates a diaphragm biasing arrangement.

45. The two-phase valve according to claim 44, wherein said diaphragm biasing arrangement comprises spring and piston member.

46. The two-phase valve according to claim 45, wherein said spring has one longitudinal end thereof anchored in the second housing portion, and an opposed longitudinal end thereof affixed to the piston member, wherein said piston member abuts said diaphragm member, and wherein said spring biases the diaphragm member against said lower valve port via said piston member.

47. The two-phase valve according to any one of claims 42 to 46, wherein said second housing portion comprises a pilot lumen providing fluid communication between the second valve unit chamber and said pilot orifice.

48. The two-phase valve according to any one of claims 34 to 47, wherein operation of said first valve arrangement and said second valve arrangement are mechanically uncoupled.

49. The two-phase valve according to any one of claims 34 to 48, wherein said first chamber and said second chamber are in vertical stacked relationship.

50. The two-phase valve according to any one of claims 34 to 49, wherein said first chamber and said second chamber are in lateral stacked relationship.

51. The two-phase valve according to any one of claims 34 to 50, wherein said first float member is different from said second float member.

52. The two-phase valve according to any one of claims 36 to 51, wherein said diaphragm aperture is smaller than or equal to in size with respect to the pilot orifice.

53. The two-phase valve according to any one of claims 36 to 52, wherein said diaphragm aperture has a diameter between about 0.1 mm and about 0.2 mm.

54. The two-phase valve according to any one of claims 36 to 53, wherein said pilot orifice a diameter between about 0.2 mm and about 0.3 mm.

55. The two-phase valve according to any one of claims 1 to 54, wherein said working fluid is a two-phase fluid that vaporizes by absorbing heat energy corresponding to the latent heat of evaporation of the fluid.

56. A cooling system for at least one battery module, comprising a cooling recirculation circuit and at least one two-phase valve as defined in any one of claims 1 to 55.

57. The cooling system according to claim 56 wherein said cooling recirculation circuit comprises a vapor phase line including a compressor, a liquid phase return line including a liquid pump, and a condenser.

58. The cooling system according to any one of claims 56 to 57, comprising at least one pressure check valve and at least one pressure holding function valve.

59. The cooling system according to any one of claims 56 to 58, wherein said vapor phase line is connected to the respective outlet port of each said two-phase valve, and wherein said liquid phase line is connected to the respective inlet port of each said two-phase valve.

60. A battery module comprising a housing defining a module chamber accommodating a plurality of electrical batteries, and further comprising at least one two-phase valve as defined in any one of claims 1 to 55.

61. The battery module according to claim 60, wherein said batteries are immersed in a liquid phase of the working fluid in said module chamber.

62. The battery module according to any one of claims 60 to 61, wherein said at least one two-phase valve is operatively connectable to a cooling system.

63. An electrical power system, comprising:
at least one battery module comprising a housing defining a module chamber accommodating a plurality of electrical batteries, and further comprising at least one two-phase valve as defined in any one of claims 1 to 55;
a cooling recirculation circuit operatively connected to said at least one battery module.

64. The electrical power system according to claim 63, wherein said cooling recirculation circuit comprises a vapor phase line including a compressor, a liquid phase return line including a liquid pump, and a condenser.

65. The electrical power system according to any one of claims 63 to 64, comprising at least one pressure check valve and at least one pressure holding function valve.

66. The electrical power system according to any one of claims 63 to 65, wherein said vapor phase line is connected to the respective outlet port of each said two-phase valve, and wherein said liquid phase line is connected to the respective inlet port of each said two-phase valve.

67. The electrical power system according to any one of claims 63 to 66, wherein for each said battery module, the respective said batteries are immersed in a liquid phase of the working fluid in said module chamber.

68. The electrical power system according to any one of claims 63 to 67, wherein each said battery module comprises two said two-phase valves.

69. The electrical power system according to claim 68, wherein for each said battery module, the respective said two two-phase valves are longitudinally spaced with respect to one another.

70. The electrical power system according to any one of claims 63 to 69, comprising a plurality of said battery modules.

71. A vehicle comprising an electrical propulsion system and an electrical power system as defined in any one of claims 63 to 70.

72. The vehicle according to claim 71, wherein said vehicle is a road vehicle.
